(19) United States
(12) Patent Application Publication
(10) Pub. No.: US 2008/0032173 A1
(43) Pub. Date: Feb. 7, 2008

(54) Hydrocarbon type polymer electrolyte, membrane/electrode assembly, and fuel cell power source

(76) Inventors: Toru Koyama, Hitachi (JP); Makoto Morishima, Hitachinaka (JP); Kenichi Souma, Mito (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/698,103

(22) Filed: Jan. 26, 2007

(30) Foreign Application Priority Data
Aug. 4, 2006 (JP) 2006-212729

(51) Int. Cl. H01M 8/10

(52) U.S. Cl. 429/33

(57) ABSTRACT

An alkylenesulfonic group and/or an alkylenesulfo-ether group is introduced as an ionic conductivity-imparting group into a polyazole such as a polyimidazole, a polyoxazole, or a polythiazole each having good resistance to oxidation. The resulting polymer yields an electrolyte, an electrolyte membrane, and a membrane electrode assembly which are available at low cost, contains ionic conductivity-imparting groups stable over extended periods of time and satisfactorily resistant to oxidative degradation. This enables long-term continuous use of mobile cell power sources, dispersed cell power sources, and cell power sources for mobile units.

### CLAIM OF PRIORITY

The present application claims priority from Japanese Application Serial No. 2006-212729, filed on Aug. 4, 2006, the content of which is hereby incorporated by reference into this application.

### FIELD OF THE INVENTION

The present invention relates to solid polymer electrolytes that are excellent typically in oxidation resistance, are inexpensive, are highly durable, and are suitable typically as electrolyte membranes. Such electrolyte membranes are used, for example, in fuel cells using a fuel such as hydrogen or methanol, as well as in electrolysis of water, electrolysis of hydraulic acids, brine electrolysis, oxygen concentrators, humidity sensors, and gas sensors. The solid polymer electrolytes are typically useful in direct methanol fuel cells. The present invention also relates to solid polymer electrolyte membranes, coating compositions for electrode catalysts, membrane electrode assemblies, fuel cells, and fuel cell power sources using the solid polymer electrolytes.

### RELATED ART

Solid polymer electrolytes are solid polymer materials having electrolytic groups in their polymer chain, such as sulforic group, alkylenesulfonic groups, phosphonic acid groups, and alkylenephosphoric acid groups. They are capable of firmly bonding with specific ions or capable of selectively allowing cations or anions to pass therethrough. Accordingly, they are molded typically into particles, fibers, and membranes and are used in various applications such as electrodialysis, diffusion dialysis, and cell diaphragms.

Some of solid polymer fuel cells use hydrogen as a fuel, and some others use liquids such as methanol, dimethylether, and ethylene glycol as a fuel. These solid polymer fuel cells have high power densities, operate satisfactorily at low temperatures and are highly environmentally friendly. Investigations have been made to practically use these solid polymer fuel cells in power sources for mobile units such as automobiles, dispersed power sources, and mobile power sources. When used in electrolysis of water, solid polymer electrolyte membranes act to electrolyze water into hydrogen and oxygen.

As inexpensive solid polymer electrolyte membranes, there have been proposed electrolyte membranes including sulfonated aromatic hydrocarbon polymers typified by engineer plastics, such as sulfonated polysulfones, sulfonated polyether sulfones, sulfonated polyether ketones, and sulfonated polyetherether sulfones. These sulfonated aromatic hydrocarbon electrolyte membranes as sulfonated derivatives of engineering plastics are more easily prepared at lower cost than fluorine-containing electrolyte membranes typified by Nafion. They, however, are disadvantageous in (1) reduction in ionic conductivity and (2) oxidative degradation and reduction in strength. More specifically, these hydrocarbon polymer membranes have sulfonic groups directly bound to aromatic rings, and such directly bound sulfonic groups may often leave by the action of an acid or heat. The resulting membranes may have reduced ionic conductivities.

When electron-donating groups such as ether groups are present in the vicinity of sulfonic groups, oxidative degradation originates in these electron-donating groups, and the membranes may have reduced strength. In particular, direct methanol fuel cells often suffer from the oxidative degradation and reduction in strength (2), because they have a low cathode potential, and hydrogen peroxide is often formed in the cathode.

As a possible solution to the reduction in ionic conductivity (1), there has been proposed the use of an alkylenesulfonic acid instead of sulfonic group (Patent Documents 1 and 2). To avoid the oxidative degradation and reduction in strength (2), there have been proposed the uses of an azole polymer in part of an aromatic hydrocarbon polymer in principal chain (Patent Documents 3, 4, 5, and 6).

In the technique described in Patent Document 3, a polybenzimidazole is introduced into part of a principal chain, while a sulfonic group is introduced into an aromatic ring in the principle chain to impart ionic conductivity, as in related art. According to this technique, the principal chain has improved resistance to oxidative degradation. However, the resulting power source is not satisfactorily durable, because the sulfonic group is directly bound to the aromatic ring and thereby often leaves by the action of an acid or heat, and the membrane has a reduced ionic conductivity and an increased resistance.

Patent Documents 4 and 5 disclose techniques in which a polybenzimidazole is introduced into a principal chain to improve the resistance to oxidative degradation, and a sulfonic group or an alkylenesulfonic group is introduced into nitrogen atom of the imidazole ring to impart ionic conductivity. Patent Document 6 discloses a technique in which a polybenzimidazole structure is introduced into a principal chain, and an alkylenephosphoric acid group is introduced to nitrogen atom of the imidazole ring to improve the oxidation resistance, and an alkylenesulfonic group is further introduced on nitrogen atom of the imidazole ring to exhibit ionic conductivity. According to the techniques disclosed in JP-A Patent Documents 5 and 6, ionic conductive groups are introduced to the nitrogen atom of the imidazole ring, and the amount of alkylenesulfonic groups to be introduced is limited. Accordingly, the resulting solid polymer electrolyte membranes show low ionic conductivities of 0.07 S/cm or less even at high temperatures of 80° C. These membranes thereby have too low ionic conductivities to be used in direct methanol fuel cells which operate at relatively low temperatures or in solid polymer fuel cells for use in mobile units.

Under these circumstances, there has been proposed an electrolyte membrane including an azole polymer having hydroxyl group bound to a carbon atom of an aromatic ring so as to avoid both reduction in ionic conductivity (1) and oxidative degradation and reduction in strength (2) (JP-A No. 2005-290318).

[Patent Document 1] Japanese Unexamined Patent Application Publications (JP-A) No. 2002-110174

[Patent Document 2] Japanese Unexamined Patent Application Publications (JP-A) No. 2003-187826

[Patent Document 3] Japanese Unexamined Patent Application Publications (JP-A) No. 2002-146018

[Patent Document 4] Japanese Unexamined Patent Application Publications (JP-A) No. Hei 9-73908

[Patent Document 5] Japanese Unexamined Patent Application Publications (JP-A) No. 2003-55457

[Patent Document 6] Japanese Unexamined Patent Application Publications (JP-A) No. 2003-178772

[Patent Document 7] Japanese Unexamined Patent Application Publication (JP-A) No. 2005-290318

### SUMMARY OF THE INVENTION

Phenolic hydroxyl groups should be introduced in larger amounts than those of sulfonic group and alkylenesulfonic groups so as to provide sufficient ionic conductivities as fuel cells, because phenolic hydroxyl groups have a lower degree of ionic dissociation than sulfonic group and alkylenesulfonic groups. Polymer electrolyte membranes containing phenolic hydroxyl groups in large amounts, however, may have reduced resistance to oxidative degradation and may be swelled with or dissolved in aqueous methanol solutions and water.

In addition, the aromatic ring having an electron-donating phenolic hydroxyl group is susceptible to oxidation. The resulting polymer electrolyte membranes are not suitable in direct methanol fuel cells which have low cathode potentials and often invite the formation of hydrogen peroxide.

Under such circumstances, an object of the present invention is to provide a hydrocarbon polymer electrolyte that is available at low cost, has a high ionic conductivity, is highly resistant to oxidative degradation, and can operate stably over extended periods of time by introducing an alkylene sulfonic group into a carbon atom of an aromatic ring of a polyazole polymer. Such polyazole polymers are highly resistant to oxidative degradation and include, for example, polyimidazoles, polyoxazoles, and polythiazoles. Another object of the present invention is to provide a membrane, a coating composition for electrodes, a membrane electrode assembly, a fuel cell, and a fuel cell power source using the hydrocarbon polymer electrolyte.

After intensive investigations, such a hydrocarbon polymer electrolyte that is available at low cost, has a high ionic conductivity and is highly resistant to oxidative degradation can be obtained by using a polyazole polymer having an alkylenesulfonic group on a carbon atom of its aromatic ring. Such polyazole polymers are excellent in resistance to oxidative degradation and include, for example, polyimidazoles, polyoxazoles, and polythiazoles. In the resulting polymer electrolyte, the alkylenesulfonic group can be introduced at low cost, is stable over extended periods of time, and contributes to satisfactory ionic conductivity, and the polyazole ring contributes to satisfactory resistance to oxidative degradation. Thus, there is provided an alkylenesulfonic group-containing polyazole electrolyte that is available at low cost, has a high ionic conductivity, and is highly resistant to oxidative degradation. The present invention has been made based on these findings.

According to an embodiment of the present invention, there is provided a polymer electrolyte which is suitable as an electrolytemembrane, has high ionic conductivity, is resistant to oxidative degradation, is available at low cost, and shows a high output and high durability. The resulting electrolyte membrane can be used typically in fuel cells using a liquid such as methanol or a gas such as hydrogen, as well as in electrolysis of water, electrolysis of water, brine electrolysis, oxygen concentrators, humidity sensors, and gas sensors. A fuel cell using the hydrocarbon electrolyte membrane is capable of stably generating electricity over extended periods of time.

### BRIEF DESCRIPTION OF THE DRAWINGS:

FIG. 1 is a diagram showing how the ionic conductivity is measured herein.

FIG. 2 is a diagram of a single cell of a solid polymer fuel cell generator according to an embodiment of the present invention.

FIG. 3 is a diagram of a membrane electrode assembly according to an embodiment of the present invention.

FIG. 4 is a graph showing the electricity generation performance of a single cell of a solid polymer fuel cell generator according to an embodiment of the present invention.

FIG. 5 is a graph showing the electricity generation performance of a single cell of a solid polymer fuel cell generator according to an embodiment of the present invention.

FIG. 6 is a graph showing the electricity generation performance of a single cell of a solid polymer fuel cell generator according to an embodiment of the present invention.

FIG. 7 is a graph showing the electricity generation performance of a single cell of a solid polymer fuel cell generator according to an embodiment of the present invention.

FIG. 8 is a graph showing the electricity generation performance of a single cell of a solid polymer fuel cell generator according to an embodiment of the present invention.

FIG. 9 is a graph showing the electricity generation performance of a single cell of a solid polymer fuel cell generator according to an embodiment of the present invention.

FIG. 10 is a graph showing the electricity generation performance of a single cell of a solid polymer fuel cell generator according to an embodiment of the present invention.

FIG. 11 is a graph showing the electricity generation performance of a single cell of a solid polymer fuel cell generator according to an embodiment of the present invention.

FIG. 12 is a graph showing the electricity generation performance of a single cell of a solid polymer fuel cell generator according to an embodiment of the present invention.

FIG. 13 is a view of a single cell of a solid polymer fuel cell generator according to an embodiment of the present invention.

FIG. 14 is a view of a fuel cell according to an embodiment of the present invention.

FIG. 15 is a view of a fuel cell power source including a fuel cell having a membrane electrode assembly according to an embodiment of the present invention.

FIG. 16 is a view of a personal digital assistant having a fuel cell power source, which includes a fuel cell using a membrane electrode assembly according to an embodiment of the present invention.

### DETAILED DESCRIPTION OF THE PREFERRED EMBODIMENTS

Some embodiments of the present invention will be illustrated in detail below.

The term “alkylenesulfonic group-containing polyazole electrolyte” for use herein means and includes aromatic polyoxazoles, polythiazoles, and polyimidazoles each containing alkylenesulfonic groups, compositions and mixtures containing any of these polymers, and copolymers of this type. Such electrolytes are generally electrolytes each having at least one of constitutional repeating units represented by following Chemical Formulae 1 and 2:

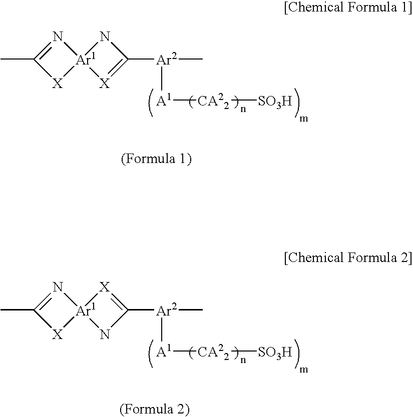

In above formulae, the units Ar¹ and Ar² each independently represent an aromatic unit. The aromatic units as Ar¹ and Ar² may be selected from, for example, monocyclic aromatic units such as benzene unit; fused aromatic units such as naphthalene, anthracene, and pyrene; polycyclic aromatic units including two or more of these aromatic units combined through an optional bond; and heteroaromatic units each including one or more of nitrogen atoms, oxygen atoms, sulfur atoms, etc. in their aromatic rings.

These aromatic units may each have one or more substituents such as aliphatic groups, aromatic groups, halogen groups, hydroxyl group, nitro group, cyano group, and trifluoromethyl group. The positions of nitrogen atoms and Xs in the aromatic unit Ar¹ are not limited, as long as these atoms constitute an azole ring. Each of Xs independently represents one of O, S and NH; A¹ represents one of a direct bond, an oxygen bond (—O—), and a sulfur bond (—S—), bound to a carbon atom of the aromatic ring; A²s each independently represent fluorine or hydrogen; “n” represents an integer of 1 to 12; and “m” represents an integer of 1 to 4.

The aromatic unit Ar¹ is preferably a unit represented by following Chemical Formula 3-1 or 3-2:

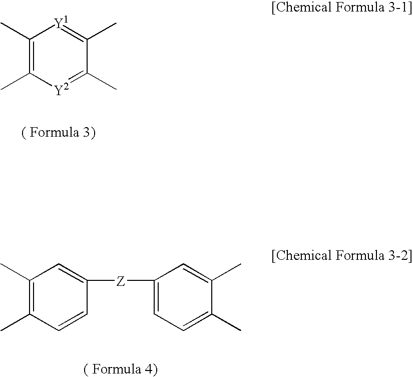

In the above formulae, Y¹ and Y² each independently represent CH or N; and Z represents a direct bond, —O—, —S—, —SO₂—, —(CH₃)₂—, —(CF₃)₂—, or —CO—.

The aromatic unit Ar² is preferably a unit represented by one of following Chemical Formulae 4-1 to 4-14:

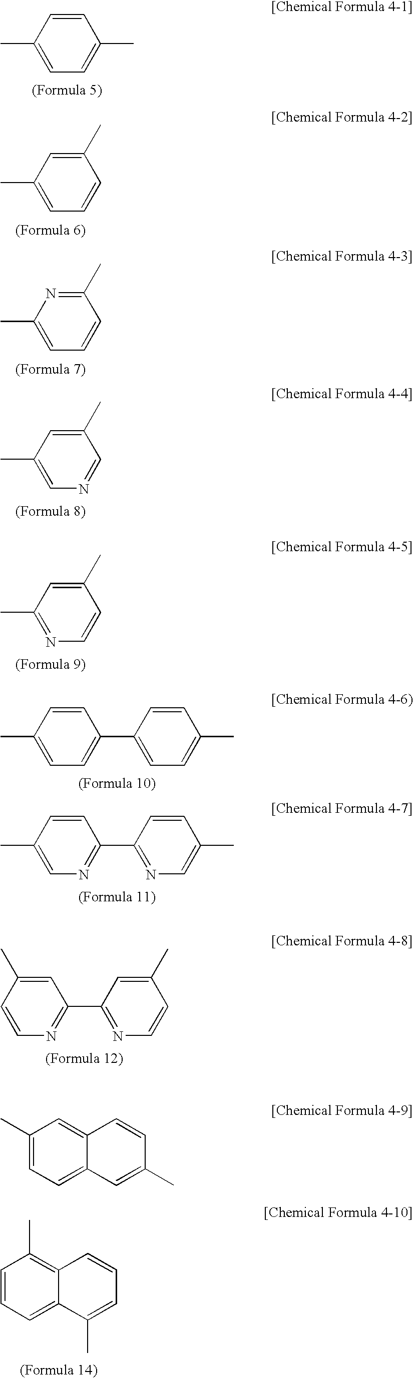

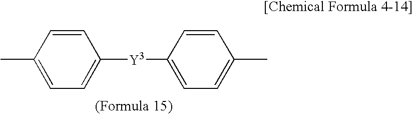

In the above formula, Y represents —O—, —S—, —SO₂—, —(CH₃)₂—, —(CF₃)₂—, or —CO—.

Specific examples of the constitutional repeating units (structural units) include, but are not limited to, units represented by following Chemical Formulae 5 to 14:

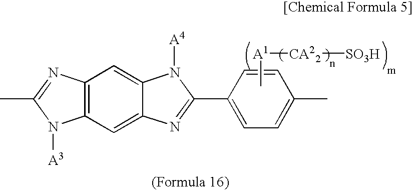

In the above formula, A¹ represents one of a direct bond, an oxygen bond (—O—), and a sulfur bond (—S—), bound to a carbon atom of the benzene ring; A²s each independently represent fluorine or hydrogen; A⁴ represents hydrogen, an alkylene group, or an alkylenesulfonic group; “n” represents an integer of 1 to 12; and “m” represents an integer of 1 to 4,

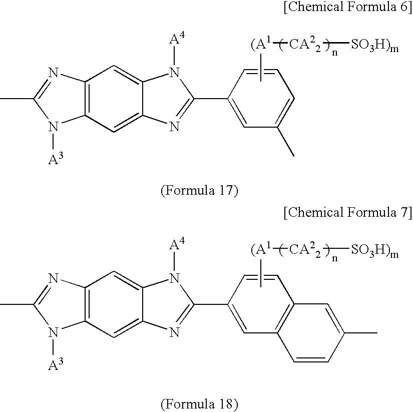

In the above formula, A¹ represents one of a direct bond, an oxygen bond (—O—), and a sulfur bond (—S—), bound to a carbon atom of the aromatic ring; A²s each independently represent fluorine or hydrogen; A³ and A⁴ each independently represent hydrogen, an alkylene group, or an alkylenesulfonic group; “n” represents an integer of 1 to 12; and “m” represents an integer of 1 to 4,

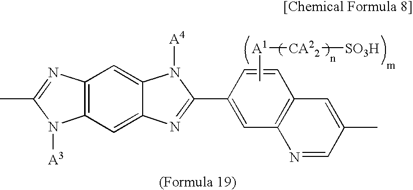

In the above formula, A¹ represents one of a direct bond, an oxygen bond (—O—), and a sulfur bond (—S—), bound to a carbon atom of the aromatic ring; A³and A⁴ each independently represent hydrogen, an alkylene group, or an alkylenesulfonic group; “n” represents an integer of 1 to 12; and “m” represents an integer of 1 to 4,

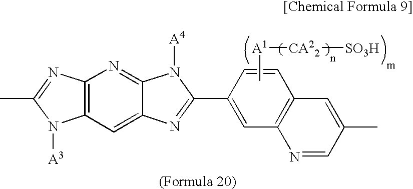

In the above formula, A¹ represents one of a direct bond, an oxygen bond (—O—), and a sulfur bond (—S—), bound to a carbon atom of the benzene ring; A³ and A⁴ each independently represent hydrogen, an alkylene group, or an alkylenesulfonic group; “n” represents an integer of 1 to 12; and “m” represents an integer of 1 to 4,

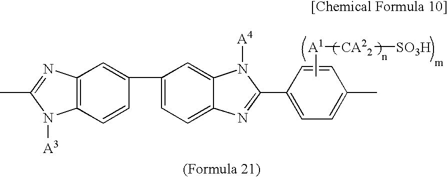

In the above formula, A¹ represents one of a direct bond, an oxygen bond (—O—), and a sulfur bond (—S—), bound to a carbon atom of the benzene ring; A²s each independently represent fluorine or hydrogen; A³ and A⁴ each independently represent hydrogen, an alkylene group, or an alkylenesulfonic group; “n” represents an integer of 1 to 12; and “m” represents an integer of 1 to 4,

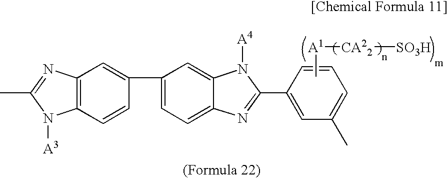

In the above formula, A¹ represents one of a direct bond, an oxygen bond (—O—), and a sulfur bond (—S—), bound to a carbon atom of the benzene ring; A²s each independently represent fluorine or hydrogen; A³ and A⁴ each independently represent hydrogen, an alkylene group, or an alkylenesulfonic group; “n” represents an integer of 1 to 12; and “m” represents an integer of 1 to 4,

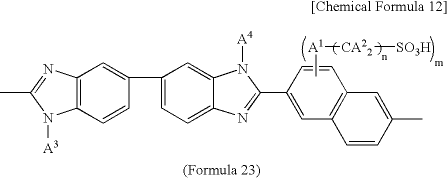

In the above formula, A¹ represents one of a direct bond, an oxygen bond (—O—), and a sulfur bond (—S—), bound to a carbon atom of the aromatic ring; A²s each independently represent fluorine or hydrogen; A³ and A⁴ each independently represent hydrogen, an alkylene group, or an alkylenesulfonic group; “n” represents an integer of 1 to 12; and “m” represents an integer of 1 to 4.

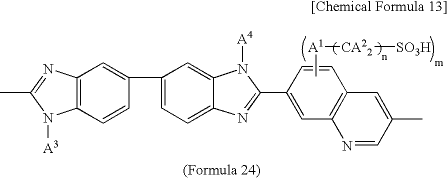

In the above formula, A¹ represents one of a direct bond, an oxygen bond (—O—), and a sulfur bond (—S—), bound to a carbon atom of the aromatic ring; A²s each independently represent fluorine or hydrogen; A³ and A⁴ each independently represent hydrogen, an alkylene group, or an alkylenesulfonic group; “n” represents an integer of 1 to 12; and “m” represents an integer of 1 to 4.

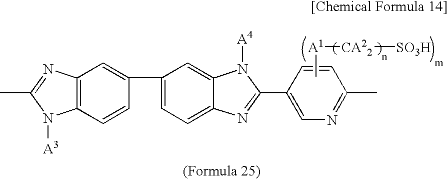

In the above formula, A¹ represents one of a direct bond, an oxygen bond (—O—), and a sulfur bond (—S—), bound to a carbon atom of the aromatic ring; A²s each independently represent fluorine or hydrogen; A³, A⁴ each independently represent hydrogen, an alkylene group, or an alkylenesulfonic group; “n” represents an integer of 1 to 12; and “m” represents an integer of 1 to 4,

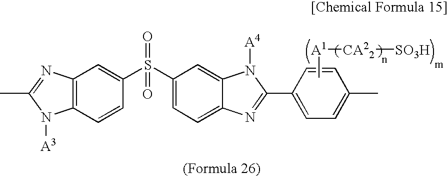

In the above formula, A¹ represents one of a direct bond, an oxygen bond (—O—), and a sulfur bond (—S—), bound to a carbon atom of the benzene ring; A²s each independently represent fluorine or hydrogen; A³, A⁴ each independently represent hydrogen, an alkylene group, or an alkylenesulfonic group; “n” represents an integer of 1 to 12; and “m” represents an integer of 1 to 4.

An azole electrolyte according to an embodiment of the present invention may be prepared, for example, by reacting at least one selected from the group consisting of aromatic diamine derivatives represented by following Chemical Formulae 16 and 17:

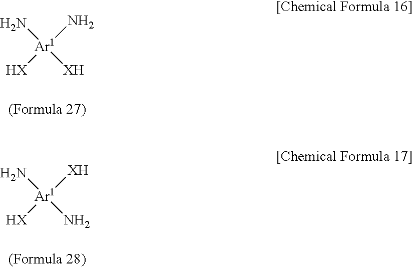

In the above formulae, each of Xs independently represents one of O, S, and NH; and Ar¹ represents a quadrivalent aromatic group having zero to four carbon atoms, and salts thereof, such as hydrochlorides, with at least one aromatic dicarboxylic acid derivative represented by following Chemical Formula 18. Alternatively, such azole electrolytes may be prepared by reacting at least one selected from the group consisting of aromatic diamine derivatives represented by Chemical Formulae 16 and 17, and salts thereof with at least one aromatic dicarboxylic acid derivative represented by following Chemical Formula 19 to yield an azole, and subjecting Ar² of the azole to sulfoalkylation, sulfoalkyl etherification, sulfoalkyl thioetherification, perfluorosulfoalkylation, perfluorosulfoalkyl etherification, or perfluorosulfoalkyl thioetherification.

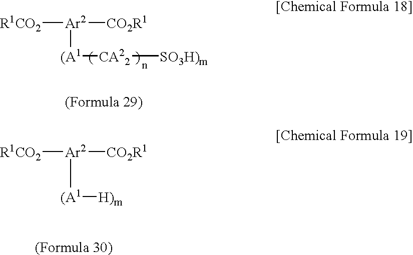

Chemical Formulae 18 and 19, Ar² represents an aromatic group having six to twenty carbon atoms; A¹ represents one of a direct bond, O, and S; A²s each independently represent fluorine or hydrogen; “n” represents an integer of 1 to 12; and “m” represents an integer of 1 to 4.

Specific examples of the aromatic groups include phenylene group, naphthalene group, anthracene group, biphenyl group, isopropylidenediphenyl group, diphenyl ether group, diphenyl sulfide group, diphenyl sulfone group, and diphenyl ketone group. One or more of hydrogen atoms of these aromatic groups may be substituted with substituents. Such substituents include halogen groups such as fluorine, chlorine, and bromine; alkyl groups; cycloalkyl groups;and alkoxycarbonyl groups. Of these aromatic groups, hydrophobic groups such as naphthalene group, anthracene group, and biphenyl group are advantageous, because such hydrophobic groups undergo intermolecular aggregation and intermolecular pseudo bridging (pseudo crosslinking) and thereby become resistant to swelling and dissolution even when they bear a large quantity of ionic conductive groups.

An electrolyte according to an embodiment of the present invention can be a block polymer prepared by subjecting a first copolymer and a second copolymer to block polymerization. The first copolymer is a copolymer of at least one selected from the group consisting of aromatic diamine derivatives represented by Chemical Formulae 16 and 17, and salts thereof, with at least one selected from aromatic dicarboxylic acid derivatives represented by Chemical Formula 18. The second copolymer is a copolymer of at least one selected from the group consisting of aromatic diamine derivatives represented by Chemical Formulae 16 and 17, and salts thereof, with at least one selected from aromatic dicarboxylic acid derivatives represented by Chemical Formula 19. The proportions of ionic conductive moieties and hydrophobic moieties in the resulting azole electrolyte can be highly precisely controlled.

An electrolyte according to an embodiment of the present invention preferably has an ionic equivalent of 0.8 to 2.5 meq/g. If the ionic equivalent is larger than this range, the electrolyte may be susceptible to swelling and dissolution in a fuel and water. If it is smaller than the range, the electrolyte may have an insufficient ionic conductivity. The amount of ionic conductive groups in the resulting polymer electrolyte may be controlled by adjusting the proportions of at least one aromatic dicarboxylic acid derivative represented by Chemical Formula 18 and at least one aromatic dicarboxylic acid derivative represented by Chemical Formula 19 in the reactions of them with at least one selected from the group consisting of aromatic diamine derivatives represented by Chemical Formulae 16 and 17, and salts thereof (e.g., hydrochlorides). The amount of ionic conductive groups may also be controlled by adjusting conditions for introducing ionic conductive groups into the aromatic unit Ar² of an azole. The azole herein is a reaction product of at least one selected from the group consisting of aromatic diamine derivatives represented by Chemical Formulae 16 and 17, and salts thereof with at least one aromatic dicarboxylic acid derivative represented by Chemical Formula 19.

When structural units represented by Chemical Formulae 1 and 2 contain NH bond, the hydrogen in NH may be substituted typically by an alkyl group, an alkylenesulfonic group, or an alkylenephosphonic acid group. In this case, the resulting electrolyte membrane may have reduced basicity.

Reactions generally proceed in the absence of a catalyst. Where necessary, the reactions are carried out in the presence of an transesterification catalyst. Transesterification catalysts for use in an embodiment of the present invention include, for example, antimony compounds such as antimony trioxide; tin compounds such as stannous acetate, tin chloride, tin octoate, dibutyltin oxide, and dibutyltin diacetate; salts of alkaline earth metals, such as calcium acetate; salts of alkali metals, such as sodium carbonate and calcium carbonate; and phosphorous esters such as diphenyl phosphite and triphenyl phosphate. Reactions may be carried out in the presence of a solvent according to necessity. Such solvents include polyphosphoric acids, sulfolane, diphenyl sulfone, dimethyl sulfoxide, N-methylpyrrolidone, and N,N′-dimethylacetamide. Reactions may be conducted in an atmosphere of a dried inert gas for suppressing decomposition and coloring of reaction products.

An electrolyte according to an embodiment of the present invention, if used in a fuel cell, is advantageously used as an electrolyte membrane and an electrode binder. When an electrolyte according to an embodiment of the present invention is formed into a membrane, the process therefor is not specifically limited. Such a membrane can be formed, for example, by solution casting in which a membrane is formed from a solution of materials. For example, a membrane can be formed by casting an electrolyte solution onto a plate, and removing a solvent. Solvents for use in membrane formation are not specifically limited, as long as they dissolve the electrolyte and can be removed after casting. Examples of solvents include aprotic polar solvents such as N,N-dimethylformamide, N,N-dimethylacetamide, dimethyl sulfoxide, N-methyl-2-pyrrolidone, and hexamethylphosphonamide; and strong acids such as polyphosphoric acids, methanesulfonic acid, sulfuric acid, and trifluoroacetic acid. Each of these solvents can be used alone or in combination. For improving solubility, organic solvents for use herein may further comprise Lewis acids such as lithium bromide, lithium chloride, and aluminum chloride.

The concentration of an electrolyte in the solution is preferably within a range of 5 to 40 percent by weight. If the concentration is excessively low, a membrane may not be satisfactorily formed. If it is excessively high, the resulting membrane may not be satisfactorily processed.

A fuel cell capable of operating at higher temperatures can be obtained by using a complex electrolyte membrane containing an azole electrolyte membrane and a hydrogen-ion conductive inorganic material finely dispersed therein. Such proton-conductive inorganic materials include, for example, tungsten oxide hydrates, zirconium oxide hydrates, tin oxide hydrates, silicotungstic acid, silicomolybdic acid, tungstophosphoric acid, and molybdic acid. Such hydrated acidic electrolyte membranes may generally vary in their volume and thereby deform between dryness and wetness. Even if they have sufficient ionic conductivity, they may have insufficient mechanical strength. In this case, it is effective to use fibers in the form of a nonwoven or woven fabric having excellent mechanical strength, durability, and thermal stability as a core; to add these fibers to electrolyte membranes for reinforcement in the production of the electrolyte membranes; or to use polymer membranes having fine through holes as a core, so as to improve the reliability of cell performance. Membranes including a polybenzimidazole doped with sulfuric acid, phosphoric acid, a sulfonic acid, and/or a phosphonic acid may be used as electrolyte membranes. The resulting electrolyte membranes may become more resistant to fuel permeation.

A polymer electrolyte membrane according to an embodiment of the present invention may further contain additives for use in regular polymers, within ranges not adversely affecting advantages of the present invention. Such additives include, for example, plasticizers, antioxidants, hydrogen peroxide decomposers, metal scavengers, surfactants, stabilizers, and mold releasing agents. The antioxidants include amine antioxidants such as phenol-α-naphthylamine, phenol-β-naphthylamine, diphenylamine, p-hydroxydiphenylamine, and phenothiazine; phenolic antioxidants such as 2,6-di(t-butyl)-p-cresol, 2,6-di(t-butyl)-p-phenol, 2,4-dimethyl-6-(t-butyl)-phenol, p-hydroxyphenylcyclohexane, di-p-hydroxyphenylcyclohexane, styrenated phenols, and 1,1′-methylenebis(4-hydroxy-3,5-t-butylphenol); sulfur-containing antioxidants such as dodecylmercaptan, dilauryl thiodipropionate, distearyl thiodipropionate, dilauryl sulfide, and mercaptobenzimidazole; and phosphorus-containing antioxidants such as trinorylphenyl phosphate, trioctadecyl phosphate, tridecyl phosphate, and trilauryl trithiophosphite.

The hydrogen peroxide decomposers are not specifically limited, as long as they have catalytic activities for decomposing peroxides, and include, for example, the antioxidants, as well as metals, metal oxides, metal phosphates, metal fluorides, and macrocyclic metal complexes. Each of these can be used alone or in combination. Among them, preferred are ruthenium (Ru) and silver (Ag) as metals; RuO, WO₃, CeO₂, and Fe₃O₄ as metal oxides; CePO₄, CrPO₄, AlPO₄, and FePO₄ as metal phosphates; CeF₃ and FeF₃ as metal fluorides; andiron-porphyrin, cobalt-porphyrin, hem, and catalase as macrocyclic metal complexes. Of these, typically preferred are RuO₂ and CePO₄, because they can further satisfactorily decompose peroxides. The metal scavengers may be any substances that can react with a metal ion such as Fe⁺⁺ or Cu⁺⁺ ion to yield a complex, thereby inactivate the metal ion and prevent the metal ion from accelerating the deterioration of membrane. Such metal scavengers include thenoyltrifluoroacetone, sodium diethyldithiocarbamate (DDTC), 1,5-diphenyl-3-thiocarbazone, as well as crown ethers such as 1,4,7,10,13-pentaoxycyclopentadecane and 1,4,7,10,113,16-hexaoxycyclopentadecane; cryptands such as 4,7,13,16-tetraoxa-1,10-diazacyclooctadecane and 4,7,13,16,21,24-hexaoxy-1,10-diazacyclohexacosane; and porphyrins such as tetraphenylporphyrin. The amount of such materials is not limited to those described in the after-mentioned examples.

Among these materials, a combination use of a phenolic antioxidant and a phosphorus-containing antioxidant is preferred, because this combination is effective even in a small amount and less adversely affects the properties of a fuel cell. These antioxidants, hydrogen peroxide decomposers, and metal scavengers may be added to an electrolyte membrane and electrodes or may be arranged between the membrane and electrodes. These additives are preferably arranged between an electrolyte membrane and a cathode and/or anode. When these additives are arranged in this manner, they exhibit their activities even in a small amount and less adversely affect the properties of a fuel cell.

In addition, an electrolyte membrane may further contain an alkylenephosphonic acid group for better oxidation resistance. In this case, an alkylenephosphonic acid group can be introduced by any process. Such processes include a process of reacting a phenolic hydroxyl group with an alkylenephosphonic acid group and introducing an oxyalkylenephosphonic acid group to a carbon atom of an aromatic ring; or a process of introducing an alkylenephosphonic acid group into a nitrogen atom of an azole ring.

The thickness of a polymer electrolyte membrane is not specifically limited and is preferably about 10 to about 300 μm, and more preferably about 15 to about 200 μm. A polymer electrolyte membrane preferably has a thickness of 10 μm or more for practically satisfactory strength and preferably has a thickness of 200 μm or less for reducing the resistance of membrane, namely, for improving electricity generation performance. When a membrane is prepared by solution casting, the thickness thereof can be controlled by adjusting the concentration of solution or the thickness of an applied film on a substrate. When a membrane is prepared from a molten material, the thickness of membrane can be controlled by preparing a film having a predetermined thickness according typically to melt pressing or melt extrusion, and drawing (stretching) the film to a predetermined draw ratio.

A binder such as a proton-conductive polymer electrolyte may be used for bonding the polymer electrolyte membrane with carbon particles bearing an anode catalyst, or for bonding carbon particles bearing an anode catalyst with each other. As the binder, an azole electrolyte according to an embodiment of the present invention can be used.

In addition, fluorine-containing polymer electrolytes and hydrocarbon electrolytes in related art maybe used as the binder. Examples of such hydrocarbon electrolytes for use as a binder include electrolytes of sulfonated engineering plastics such as sulfonated poly(ether ether ketone)s, sulfonated poly(ether sulfone)s, sulfonated acrylonitrile-butadiene-styrene polymers, sulfonated polysulfides, and sulfonated polyphenylenes; electrolytes of sulfoalkylated engineering plastics such as sulfoalkylated poly(ether ether ketone)s, sulfoalkylated poly(ether sulfone)s, sulfoalkylated poly(ether ether sulfone)s, sulfoalkylated polysulfones, sulfoalkylated polysulfides, sulfoalkylated polyphenylenes, and sulfoalkylated poly(ether ether sulfone)s; and sulfoalkyl-etherified polyphenylenes.

Among them, preferred are hydrocarbon polymer electrolytes that are satisfactorily resistant to oxidation and resistant to (insoluble in) an aqueous methanol solution. The amount of ionic conductive groups in the polymer electrolyte membrane as a binder is preferably about 0.5 to about 2.5 milliequivalents per gram of dried resin, and more preferably about 0.8 to about 1.8 milliequivalents per gram of dried resin. The polymer electrolyte preferably has a sulfonic acid equivalent larger than that of a polymer electrolyte membrane from the viewpoint of ionic conductivity. The amount of oxidation-resistance imparting groups in the polymer electrolyte membrane as a binder is preferably about 0.5 to about 2.5 milliequivalents per gram of dried resin, and more preferably about 0.8 to about 1.8 milliequivalents per gram of dried resin.

The fluorine-containing polymer electrolytes for use as a binder can be any fluorine-containing electrolytes, such as poly(perfluorosulfonic acid)s. Representative examples thereof include Nafion (registered trademark: E. I. du Pont de Nemours and Company, Wilmington, Del., USA), Aciplex (registered trademark: Asahi Chemical Industry, Co., Ltd., Japan), and Flemion (registered trademark: Asahi Glass Co., Ltd., Japan). These fluorine-containing electrolytes preferably have a sulfonic acid equivalent larger than that of the polymer electrolyte membrane from the viewpoint of ionic conductivity. The electrolyte for use as a binder is preferably a hydrocarbon electrolyte, because such hydrocarbon electrolytes can bond with a hydrocarbon electrolyte membrane satisfactorily.

Such electrolytes for use as a binder may further contain additives for use in regular polymers within ranges not adversely affecting advantages of the present invention. Such additives include, for example, plasticizers, antioxidants, hydrogen peroxide decomposers, metal scavengers, surfactants, stabilizers, and mold releasing agents.

Anode catalysts and cathode catalysts for use herein can be any metals that accelerate or promote the oxidation reaction of a fuel and the reducing reaction of oxygen. Examples of metals are platinum, gold, silver, palladium, iridium, rhodium, ruthenium, iron, cobalt, nickel, chromium, tungsten, manganese, vanadium, titanium and alloys of these metals. Of these catalysts, often used are platinum (Pt) as a cathode catalyst, and a platinum/ruthenium catalyst (Pt/Ru) as an anode catalyst. A metal used as a catalyst may be in the form of particles having particle diameters of generally about 2 to about 30 nm. These catalysts are advantageously supported by carriers such as carbon.

Such supported catalysts can be used in smaller amounts and thereby economically advantageous. The amount of a catalyst supported on a carrier arranged in an electrode is preferably about 0.01 to 20 mg/cm².

Electrodes for use in a membrane electrode assembly include electroconductive materials (electroconductive carriers) bearing fine particles of a catalytic metal and may further include a water repellant and/or a binder according to necessity. Electrodes may include a catalyst layer and another layer arranged outside the catalyst layer. The other layer contains an electroconductive material bearing no catalyst and may further contain a water repellant and/or a binder according to necessity. The electroconductive material (carrier) to bear a catalytic metal can be any electroconductive substances and includes, for example, metals and carbon materials.

Such carbon materials include, for example, carbon black materials such as furnace black, channel black, and acetylene black; fibrous carbon materials such as carbon nanotubes; activated carbons; and graphite. Each of these can be used alone or in combination.

The water repellant can be, for example, carbon fluoride. The binder is preferably a solution of a hydrocarbon electrolyte of the same kind as the electrolyte membrane for satisfactory adhesion. However, any other resins can also be used. Water-repellent fluorine-containing resins may also be used herein. Examples of such resins are polytetrafluoroethylenes, tetrafluoroethylene-perfluoroalkyl vinyl ether copolymers, and tetrafluoroethylene-hexafluoropropylene copolymers.

A polymer electrolyte membrane and electrodes can be bonded according to any procedure so as to constitute a membrane electrode assembly for use typically in a fuel cell. A membrane electrode assembly can be prepared by various processes. It can be prepared, for example, by a process including the steps of mixing an electroconductive material such as catalytic platinum particles supported on carbon with a polytetrafluoroethylene suspension; applying the mixture to a carbon paper; carrying out a heat treatment to yield a catalyst layer; applying a solution, as a binder, of a polymer electrolyte of the same kind as the polymer electrolyte membrane or a fluorine-containing electrolyte to the catalyst layer; and integrating the catalyst layer with the polymer electrolyte membrane by hot pressing.

A membrane electrode assembly may also be prepared by a process of applying a solution of a polymer electrolyte of the same kind as the polymer electrolyte membrane to catalytic platinum particles by coating; a process of applying a catalyst paste to a polymer electrolyte membrane typically by printing, spraying, or an ink-jet process; a process of forming an electrode onto a polymer electrolyte membrane by electroless plating; or a process of allowing a polymer electrolyte membrane to adsorb complex ions of a platinum group metal, and reducing the ions. Among these processes, the process of applying a catalyst paste to a polymer electrolyte membrane by an ink-jet process is desirable, because the catalyst can be used with less loss according to this process.

Fuel cells are preferably operated at high temperatures for higher catalytic activity of electrodes and for reducing the overvoltage of electrodes. However, operation temperatures of fuel cells are not specifically limited. It is also acceptable to operate fuel cells at high temperatures by vaporizing a liquid fuel cell. An electrolyte membrane according to an embodiment of the present invention is suitable in devices operating at high temperatures.

A fuel cell can be prepared, for example, in the following manner. Cells (single cells) are initially prepared by arranging a fuel channel plate and an oxidant channel plate outside the membrane electrode assembly. The fuel channel plate and oxidant channel plate act as current collectors and have channels to constitute a fuel passage and an oxidant passage, respectively. A fuel cell is prepared by stacking a plurality of single cells with the interposition typically of a cooling plate, or arraying single cells in one plane. Single cells may be connected by stacking or by arraying in one plane, and the arrangement thereof is not specifically limited.

For reducing size and weight of a device using fuel cells, single cells may be arrayed and connected in one plane without using auxiliary mechanisms. Fuel cells are preferably passive fuel cells, in which a fuel is fed typically using a cartridge, and air is fed using natural aspiration without auxiliary mechanisms. A compact power source can be provided by preparing single cells each including an anode, an electrolyte membrane, and a cathode, arraying the single cells in one plane, and connecting the single cells in series through an electroconductive interconnector. The resulting compact power source can yield a high voltage and can operate even without using an auxiliary mechanism for forcedly supplying a fuel and an oxidant and without using an auxiliary mechanism for forcedly cooling fuel cells.

By using an aqueous methanol solution having a high volume energy density as a liquid fuel, the compact power source can continuously generate electricity over extended periods of time. Such compact power sources may be mounted as a power source typically in devices such as mobile phones, notebook-sized personal computers, and mobile video cameras and can drive these devices. They can be continuously used over extended periods of time by sequentially refueling a previously provided fuel. A compact power source is effectively used as a battery charger by connecting the power source with a charger typically of mobile phones, notebook-sized personal computers and mobile video cameras bearing secondary batteries, and housing the power source within a casing of these devices. This configuration may significantly save the frequency of refueling.

Such a mobile electronic device is taken out of the casing and is driven by the action of a secondary battery upon use. After use, the device is housed in the casing, and is thereby connected to the compact fuel cell generator (compact power source) in the casing through the charger so as to charge the secondary battery. By configuring this, a fuel tank may have a larger capacity, and the frequency of refueling can be significantly reduced.

Fuel cells such as direct methanol fuel cells in related art may become incapable of operating in a short period of time, because electrolyte membranes and electrodes used in the fuel cells undergo oxidative degradation, or ionic conductive groups contained therein leave. Test results in following Examples and Comparative Examples demonstrate as follows. By introducing an alkylenesulfonic group into a carbon atom of an aromatic ring of a polyazole polymer, the resulting electrolytes, electrolyte membranes, and membrane electrode assemblies can be obtained at low cost, can contain large amounts of ionic conductivity-imparting groups, and are resistant to oxidative degradation. Such polyazole polymers are highly resistant to oxidative degradation and include, for example, polyimidazoles, polyoxazoles, and polythiazoles.

The present invention will be illustrated in further detail with reference to several examples and comparative examples below, which by no means limit the scope of the present invention. The properties of samples were determined in the following manner.

### (1) Determination of Ionic Conductivity

A strip specimen of an electrolyte membrane 5 mm wide and 25 mm long was left in ion-exchanged water at 30° C. for about fifteen hours, and water attached to the surface of the strip specimen was wiped off with a filter paper. Five platinum wires having a diameter of 0.2 mm were arranged at intervals of 5 mm and pressed to the specimen, and the resulting article was left stand in a thermohygrostat at 30° C. and 95% relative humidity. Alternating-current resistances were determined by measuring alternating-current impedance between the platinum electrodes at 10 kHz. A contact resistance occurs between a platinum electrode (platinum wire) and the electrolyte membrane. An alternating-current resistance was measured at a varying interval between the platinum electrodes of 5, 10, 15, and 20 mm. A specific resistance was calculated based on the interval (distance) between the platinum electrodes and the slope of the alternating-current resistance according to following Equation 1, so as to avoid the influence of the contact resistance. The resistance meter and the thermohygrostat used herein were 4284 ALCR Meter (Agilent Technologies, Inc.) and SH-220 (ESPEC CORPORATION), respectively. There was found a good linear relation between the electrode interval and the alternating-current resistance. The specific resistance was determined according to Equation 1 to thereby eliminate the influence of the contact resistance. The ionic conductivity was determined by calculation according to following Equation 2.

Specific resistance (Q·cm)=[Width (cm)×Thickness (cm)×(Slope of alternating-current resistance (Q/cm))] (1)

Ionic conductivity (S/cm)=1/(Specific resistance) (2)

### (2) Determination of Oxidation Resistance

A sample electrolyte membrane was immersed in a Fenton's reagent at a constant temperature of 60° C., and the time period until the electrolyte membrane was dissolved was determined. The Fenton's reagent contained 1.9 mg of ferrous sulfate heptahydrate in 20 ml of a 30% aqueous hydrogen peroxide solution.

### (3) Generation Performance of Direct-Methanol Fuel Cells (DMFCs)

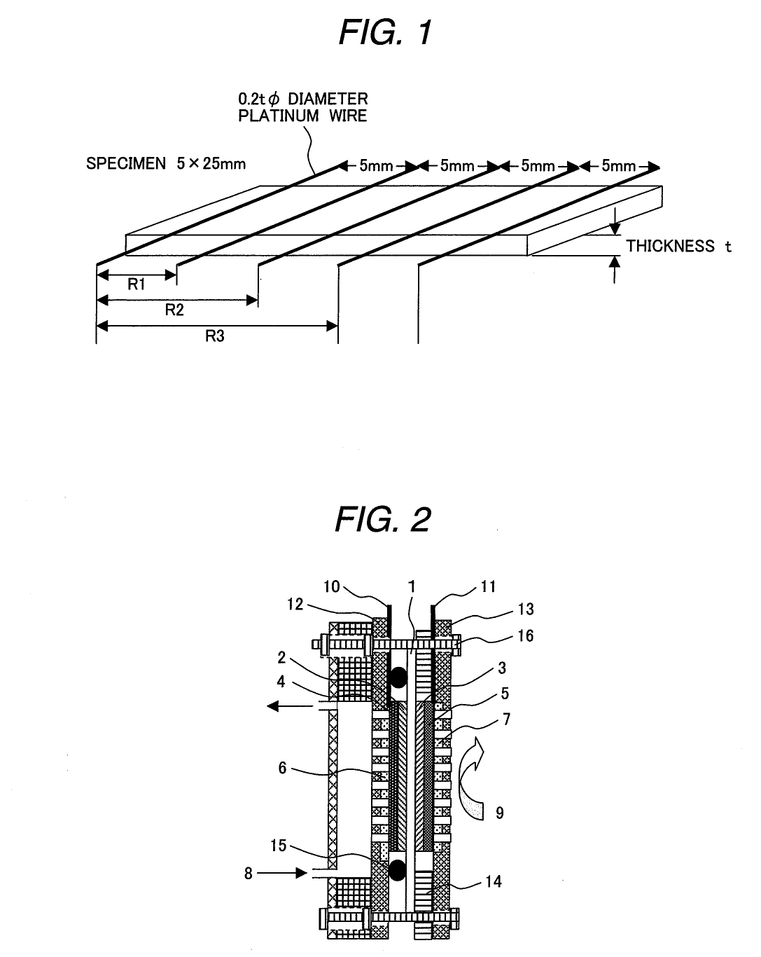

A sample membrane electrode assembly (MEA) bearing diffusion layers was mounted to a single cell of solid polymer fuel cell generator having a structure as shown in FIG. 2, and the cell performance thereof was determined. FIG. 2 illustrates a polymer electrolyte membrane 1, an anode 2, a cathode 3, an anode diffusion layer 4, a cathode diffusion layer 5, an anode current collector 6, a cathode current collector 7, a fuel 8, air 9, an anode terminal 10, a cathode terminal 11, an anode end plate 12, a cathode end plate 13, a gasket 14, an O-ring 15, and bolts and nuts 16. A 20 percent by weight aqueous methanol solution as the fuel was circulated to the anode, and air was fed to the cathode. The cells were continuously operated under a load of 50 mA/cm² at 30° C. for 4000 hours, and the output voltage was then determined.

### EXAMPLE 1

### (1) Preparation of Polyhydroxybenzimidazole

In a three-neck flask equipped with a stirrer and a nitrogen feed tube were dissolved 8.035 g (37.5 mmol) of 3,3′,4,4′-tetraaminobiphenyl and 13.137 g (37.5 mmol) of diphenyl 2,5-dihydroxyisophthalate in 200 ml of sulfolane, and oxygen was removed by feeding nitrogen gas into the flask. The mixture was heated under ref lux in an atmosphere of nitrogen gas flow for ninety-six hours, was cooled to room temperature, and was poured into a mixture containing 1 liter of methanol and 0.5 liter of acetone. The precipitated polymer was filtered, was sequentially washed with distilled water and acetone, was dried, and thereby yielded a polyhydroxybenzimidazole containing a structural unit represented by Chemical Formula 20:

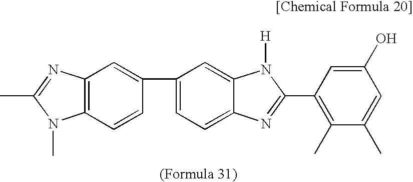

### (2) Preparation of Poly-Sulfobutoxy-Benzimidazole

The polyhydroxybenzimidazole having the structural unit of Chemical Formula 20 (10.6 g) was dissolved in 87 g of N-methylpyrrolidone under flow of nitrogen gas. The solution was combined with 10 g of a solution of sodium ethoxide in ethanol with stirring. The resulting mixture was combined with 10 g of butanesultone added dropwise. After the completion of dropwise addition, the mixture was held to 80° C. for three hours. The reaction mixture was cooled and was poured into a mixture containing 1 liter of methanol and 0.5 liter of acetone. The precipitates were filtered, were sequentially washed with distilled water and acetone, were dried, and thereby yielded a poly-sulfobutoxy-benzimidazole having a structural unit represented by Chemical Formula 21:

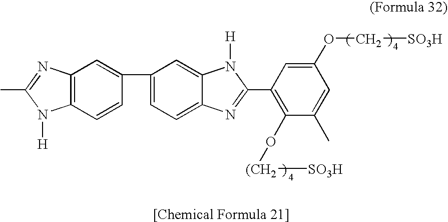

### (3) Preparation of Poly-Sulfobutyl-Sulfobutoxy-Benzimidazole

The polyhydroxybenzimidazole having the structural unit of Chemical Formula 20 (10.6 g) was dissolved in 87 g of N-methylpyrrolidone under flow of nitrogen gas in a three-neck flask equipped with a stirrer and a nitrogen feed tube. Next, the solution was combined with 1.0 g of lithium hydride and was held to a temperature of 70° C. for twelve hours. After the completion of bubbling, 18 g of butanesultone was gradually added dropwise. The reaction mixture was held to 70° C. for twelve hours, was cooled, and was poured into a mixture containing 1 liter of methanol and 0.5 liter of acetone The precipitates were filtered, were sequentially washed with distilled water and acetone, were dried, and thereby yielded a poly-sulfobutyl-sulfobutoxy-benzimidazole containing a structural unit represented by Chemical Formula 22:

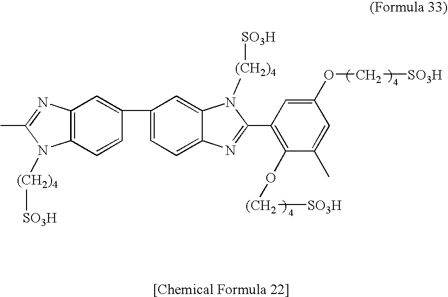

### (4) Preparation of Polymer Electrolyte Membrane and Evaluation Thereof

The poly-sulfobutoxy-benzimidazole prepared in the step (2) and having a structural unit represented by Chemical Formula 22 was dissolved in N-methylpyrrolidone to yield a 5 percent by weight solution. The solution was applied to glass by spin coating, was air-dried, was dried at 80° C. in vacuo, and thereby yielded a poly-sulfobutoxy-benzimidazole electrolyte membrane (1) having a thickness of 45 μm. The polymer electrolyte membrane had an ionic conductivity at room temperature of 0.12 S/cm. The polymer electrolyte membrane was immersed in a 40 percent by weight aqueous methanol solution at 60° C. for seventy-two hours, was dried under reduced pressure, and was weighed. The polymer electrolyte membrane showed substantially no difference in dry weight between before and after immersion and was found to be insoluble in methanol. In addition, the polymer electrolyte membrane was immersed in a Fenton s reagent at a temperature of 60° C. for twenty-four hours, was washed with water, was dried under reduced pressure, and the weight and ionic conductivity of the membrane were measured. The Fenton's reagent contained 1.9 mg of ferrous sulfate heptahydrate in 20 ml of a 30% aqueous hydrogen peroxide solution. The polymer electrolyte membrane showed substantially no difference in weight and ionic conductivity between before and after immersion to find to be satisfactorily resistant to oxidation.

The poly-sulfobutyl-sulfobutoxy-benzimidazole prepared in the step (3) and having a structural unit represented by Chemical Formula 22 was dissolved in N-methylpyrrolidone to yield a 5 percent by weight solution. The solution was applied to glass by spin coating, was air-dried, was dried at 80° C. in vacuo, and thereby yielded a poly-sulfobutyl-sulfobutoxy-benzimidazole electrolyte membrane (2) having a thickness of 45 μm. The poly-sulfobutyl-sulfobutoxy-benzimidazole electrolyte membrane (2) had an ionic conductivity at room temperature of 0.15 S/cm. The poly-sulfobutyl-sulfobutoxy-benzimidazole (1) was insoluble in methanol and had good oxidation resistance, as in the poly-sulfobutyl-sulfobutoxy-benzimidazole electrolyte membrane (1) prepared in the step (2) from the poly-sulfobutoxy-benzimidazole having a structural unit represented by Chemical Formula 21.

### (5) Preparation of Membrane Electrode Assemblies (MEAs)

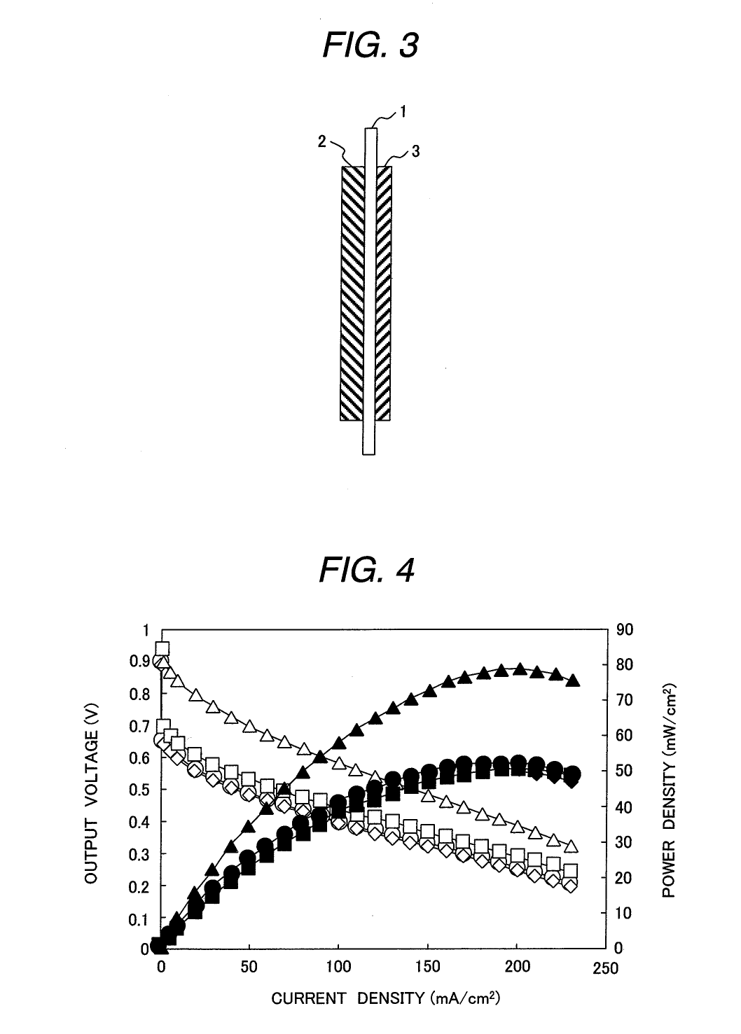

A membrane electrode assembly (MEA) (1) having a structure as shown in FIG. 3 was prepared in the following manner. Initially, a slurry was prepared by mixing a catalyst powder, a 5 percent by weight of a poly(perfluorosulfonic acid) electrolyte, and a solvent mixture of 1-propanol, 2-propanol, and methoxyethanol. The catalyst powder used herein contained a carbon carrier and 50 percent by weight of fine particles of a platinum/ruthenium alloy dispersed and supported on the carbon carrier, which alloy has an atomic ratio of platinum to ruthenium of 1:1. The slurry was applied to a polyimide film by screen printing and thereby yielded an anode having a thickness of about 125 μm, a width of 30 mm, and a length of 30 mm. Next, another slurry was prepared by mixing a catalyst powder, a binder, and a solvent mixture of water and alcohols. The catalyst powder contained a carbon carrier and 30 percent by weight of platinum fine particles supported on the carbon carrier. The binder was a solution of a poly(perfluorosulfonic acid) in a solvent mixture of 1-propanol, 2-propanol, and methoxyethanol. The slurry was applied to a polyimide film by screen printing and thereby yielded a cathode having a thickness of about 20 μm, a width of 30 mm, and a length of 30 mm. Next, about 0.5 ml of a solution was allowed to permeate the surface of the anode. The solution was a 5 percent by weight solution of a poly(perfluorosulfonic acid) electrolyte in a solvent mixture of 1-propanol, 2-propanol, and methoxyethanol. The anode was then bonded with one side of the poly-sulfobutyl-benzimidazole electrolyte membrane (1) prepared in the step (4), and the article was dried at 80° C. under a load of 1 kg for three hours. Next, about 0.5 ml of another solution was allowed to permeate the surface of the cathode. The solution was a 5 percent by weight solution of a poly(perfluorosulfonic acid) electrolyte in a solvent mixture of 1-propanol, 2-propanol, and methoxyethanol. The cathode was bonded with the other side of the poly-sulfobutoxy-benzimidazole electrolyte membrane opposite to the anode layer, so that the cathode layer overlay the anode layer with the interposition of the membrane. The resulting article was dried at 80° C. under a load of about 1 kg for three hours and thereby yielded the membrane electrode assembly (MEA) (1).

A membrane electrode assembly (MEA) (2) having a structure as shown in FIG. 3 was prepared in the following manner. Initially, a slurry was prepared by mixing a catalyst powder, 30 percent by weight of the poly-sulfobutoxy-benzimidazole electrolyte prepared in the step (2), and a solvent mixture of 1-propanol, 2-propanol, and methoxyethanol. The catalyst powder used herein contained a carbon carrier and 50 percent by weight of fine particles of a platinum/ruthenium alloy dispersed and supported on the carbon carrier, which alloy has an atomic ratio of platinum to ruthenium of 1:1. The slurry was applied to a polyimide film by screen printing and thereby yielded an anode having a thickness of about 125 μM, a width of 30 mm, and a length of 30 mm. Next, another slurry was prepared by mixing a catalyst powder, a binder, and a solvent mixture of water and alcohols. The catalyst powder contained a carbon carrier and 30 percent by weight of platinum fine particles supported on the carbon carrier. The binder was a solution of a poly(perfluorosulfonic acid) in a solvent mixture of 1-propanol, 2-propanol, and methoxyethanol. The slurry was applied to a polyimide film by screen printing and thereby yielded a cathode having a thickness of about 20 μm, a width of 30 mm, and a length of 30 mm. Next, about 0.5 ml of a solution was allowed to permeate the surface of the anode. The solution was a 5 percent by weight solution of the poly-sulfobutoxy-benzimidazole electrolyte prepared in the step (1) in a solvent mixture of 1-propanol, 2-propanol, and methoxyethanol.

The anode was then bonded with one side of the poly-sulfobutyl-benzimidazole electrolyte membrane (2) prepared in the step (4), and the article was dried at 80° C. under a load of 1 kg for three hours. Next, about 0.5 ml of another solution was allowed to permeate the surface of the cathode. The solution was a 5 percent by weight solution of a poly(perfluorosulfonic acid) in a solvent mixture of 1-propanol, 2-propanol, and methoxyethanol. The cathode was bonded with the other side of the poly-sulfobutyl-sulfobutoxy-benzimidazole electrolyte membrane (2) opposite to the anode layer so that the cathode layer overlay the anode layer with the interposition of the membrane.

The resulting article was dried at 80° C. under a load of about 1 kg for three hours and thereby yielded the membrane electrode assembly (MEA) (2).

Membrane electrode assemblies (MEAs) (3) and (4) were prepared in the following manner. Slurries were prepared by mixing a catalyst powder and a 30 percent by weight solution of each of the poly-sulfobutoxy-benzimidazole electrolyte and the poly-sulfobutyl-sulfobutoxy-benzimidazole electrolyte prepared in the step (2) and (3), respectively, in a solvent mixture of 1-propanol, 2-propanol, and methoxyethanol. The catalyst powder used herein contained a carbon carrier and 50 percent by weight of fine particles of a platinum/ruthenium alloy dispersed and supported on the carbon carrier, which alloy has an atomic ratio of platinum to ruthenium of 1:1. Each of the slurries was applied to a polyimide film by screen printing and thereby yielded an anode having a thickness of about 125 μm, a width of 30 mm, and a length of 30 mm. Next, another slurry was prepared by mixing a catalyst powder, a binder, and a solvent mixture of water and alcohols.

The catalyst powder contained a carbon carrier and 30 percent by weight of platinum fine particles supported on the carbon carrier. The binder was a solution of a poly (perfluorosulfonic acid) in a solvent mixture of 1-propanol, 2-propanol, and methoxyethanol. The slurry was applied to a polyimide film by screen printing and thereby yielded a cathode having a thickness of about 20 μm, a width of 30 mm, and a length of 30 mm. Next, about 0.5 ml of a solution was allowed to permeate the surface of the anode. The solution was a 5 percent by weight solution of the poly-sulfobutoxy-benzimidazole electrolyte prepared in the step (2) in a solvent mixture of 1-propanol, 2-propanol, and methoxyethanol. The anode was bonded with one side of the poly-sulfobutyl-sulfobutoxy-benzimidazole electrolyte membrane (2) prepared in the step (4), and the article was dried at 80° C. under a load of 1 kg for three hours. Next, about 0.5 ml of another solution was allowed to permeate the surface of the cathode. The solution was a 5 percent by weight solution of the poly-sulfobutoxy-benzimidazole electrolyte prepared in the step (2) in a solvent mixture of 1-propanol, 2-propanol, and methoxyethanol. The cathode was bonded with the other side of the poly-sulfobutyl-sulfobutoxy-benzimidazole electrolyte membrane (2) opposite to the anode layer so that the cathode layer overlay the anode layer with the interposition of the membrane. The resulting article was dried at 80° C. under a load of about 1 kg for three hours and thereby yielded the membrane electrode assemblies (MEAs) (3) and (4).

Anode and cathode diffusion layers were prepared in the following manner. A paste was prepared by adding 40 percent by weight in terms of weight after firing of an aqueous dispersion of polytetrafluoroethylene (PTFE) fine particles (Dispersion D-1: Daikin Industries, Ltd.) as a water repellant to carbon powder particles, and kneading the mixture. The paste was applied to one side of a carbon cloth having a thickness of about 350 μm and a porosity of 87%, was dried at room temperature, was fired at 270° C. for three hours, and thereby yielded a carbon sheet. The amounts of the polytetrafluoroethylene (PTFE) were set to 5 to 20 percent by weight relative to the weight of the carbon cloth. The sheet was cut to the same size as the electrodes of the membrane electrode assemblies (MEAs) (1), (2), (3), and (4) and thereby yielded a cathode diffusion layer.

A carbon cloth having a thickness of about 350 μm and a porosity of 87% was immersed in fuming sulfuric acid (concentration: 60%) in a flask and was held at a temperature of 60° C. in an atmosphere of nitrogen gas flow for two days. Next, the flask was cooled to room temperature. After removing fuming sulfuric acid, the carbon cloth was fully washed until the distilled water became neutral. Next, the carbon cloth was immersed in methanol and was dried. The resulting carbon cloth had an infrared absorption spectrum showing absorptions derived from —OSO₃H group at 1225 cm⁻¹ and 1413 cm⁻¹, and an absorption derived from —OH group at 1049 cm⁻¹.

This demonstrates that the surface of the carbon cloth bears —OSO₃H groups and —OH groups introduced thereto. In this connection, a carbon cloth not treated with fuming sulfuric acid has a contact angle with an aqueous methanol solution of 81°. The treated carbon cloth, however, had a contact angle with an aqueous methanol solution less than 81° to find to be hydrophilic. In addition, the carbon cloth was excellent in electro conductivity. The carbon cloth was cut to a piece having the same size as the electrodes of the membrane electrode assemblies (MEAs) (1) to (4) and thereby yielded an anode diffusion layer.

### (6) Generation Performance of Fuel Cells (Direct-Methanol Fuel Cells (DMFCs))

Each of the membrane electrode assemblies (MEAs) (1), (2), (3), and (4) bearing the diffusion layers was mounted to a single cell of solid polymer fuel cell generator having a structure as shown in FIG. 2, and cell performance thereof was determined. FIG. 4 shows how the output voltages of the cells vary depending on the current density. In FIG. 4, data indicated by the open circle (◯), open rhombus ( [symbol] ), open square (□), and open triangle ( [symbol] ) represent data on the relationship between the output voltage and the current density of the membrane electrode assemblies (MEAs) (1), (2), (3), and (4), respectively. Data indicated by the filled circle (), filled rhombus (♦), filled square (▪), and filled triangle (▴) represent data on the relationship between the output voltage and the power density of the membrane electrode assemblies (MEAs) (1), (2), (3), and (4), respectively. The membrane electrode assemblies (MEAs) (1), (2), (3), and (4) showed output voltages under a load at a current density of 50 mA/cm² of 0.54 V, 0.49 V, 0.49 V, and 0.70 V, respectively, and showed highest power densities of 55 mW/cm², 52 mW/cm², 52 mW/cm², and 78 mW/cm², respectively.

After 4000-hour operation under a load at a current density of 50 mA/cm², they showed output voltages of 0.51 V, 0.45 V, 0.44 V, and 0.65 V, respectively, which are 90% or more of the initial output voltages. These results demonstrate that the fuel cells can operate stably over extended periods of time.

### EXAMPLE 2

### (1) Preparation of Polysulfomethylbenzimidazole

In a three-neck flask equipped with a stirrer and a nitrogen feed tube were placed 8.035 g (37.5 mmol) of 3,3′,4,4′-tetraaminobiphenyl, 10.17 g (37.5 mmol) of 2,5-dicarboxy-1,4-sulfomethylbenzene monosodium salt, 110 g of polyphosphoric acid (phosphorus pentoxide content: 75%), and 87.9 g of phosphorus pentoxide. The mixture was gradually raised in temperature to 100° C. under flow of nitrogen gas, was kept to 100° C. for one and a half hours, was raised in temperature to 150° C., and was kept to 150° C. for one hour. Next, the mixture was raised in temperature to 200° C. and was kept to 200° C. for four hours.

After cooling to room temperature, the mixture was combined with water, the contents were taken out, were pulverized in a mixer, and were washed with water repeatedly until the filtrate became neutral on a pH indicator paper. The resulting polymer was dried under reduced pressure and thereby yielded a polysulfomethylbenzimidazole having a structural unit represented by Chemical Formula 23:

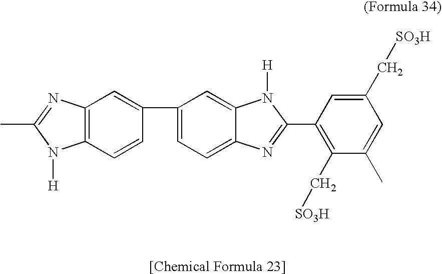

### (2) Preparation of Polysulfomethylbenzimidazole

In a three-neck flask equipped with a stirrer and a nitrogen feed tube were placed 200 ml of dimethylacetamide, 16.3 g (113 mmol) of 2-chloroethylphosphonic acid, and 11.4 g (113 mmol) of triethylamine. The mixture was stirred at room temperature in an atmosphere of nitrogen gas flow for about one hour and thereby yielded a solution of triethylamine salt of 2-chloroethylphosphonic acid. In 200 ml of dimethylacetamide was dissolved 15.75 g (37.5 mmol) of the polysulfomethylbenzimidazole prepared in the step (1) and having a structural unit represented by Chemical Formula 23 in an atmosphere of nitrogen gas flow, the solution was combined with 1.35 g (170 mmol) of lithium hydride and was stirred at 85° C. for four hours.

This was combined with the solution of triethylamine salt of 2-chloroethylphosphonic acid added dropwise and was stirred for twenty-four hours. The reaction mixture was poured onto acetone, the precipitates were filtered, were dried under reduced pressure, and thereby yielded a polysulfomethylbenzimidazole having a structural unit represented by Chemical Formula 24:

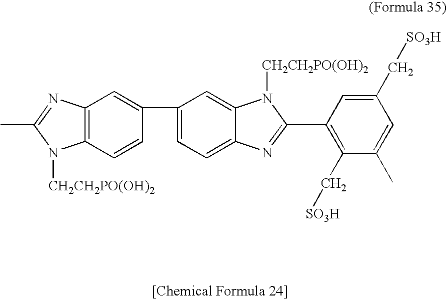

### (3) Preparation of Polymer Electrolyte Membrane and Evaluation Thereof

The polysulfomethylbenzimidazole prepared in the step (1) and having a structural unit represented by Chemical Formula 23 was dissolved in N-methylpyrrolidone to yield a 5 percent by weight solution. The solution was applied to glass by spin coating, was air-dried, was dried at 80° C. in vacuo, and thereby yielded a polysulfobutylbenzimidazole electrolyte membrane having a thickness of 45 μm. The polymer electrolyte membrane had an ionic conductivity at room temperature of 0.08 S/cm.

The polymer electrolyte membrane was immersed in a 40 percent by weight aqueous methanol solution at 60° C. for seventy-two hours, was dried under reduced pressure, and was weighed. The polymer electrolyte membrane showed substantially no difference in dry weight between before and after immersion and was found to be insoluble in methanol.

In addition, the polymer electrolyte membrane was immersed in a Fenton's reagent at a temperature of 60° C. for twenty-four hours, was washed with water, was dried under reduced pressure, and the weight and ionic conductivity of the membrane were measured. The polymer electrolyte membrane showed substantially no difference in weight and ionic conductivity between before and after immersion to find to be satisfactorily resistant to oxidation. The Fenton's reagent contained 1.9 mg of ferrous sulfate heptahydrate in 20 ml of a 30% aqueous hydrogen peroxide solution.

The polysulfomethylbenzimidazole prepared in the step (2) and having a structural unit represented by Chemical Formula 24 was dissolved in N-methylpyrrolidone to yield a 5 percent by weight solution. The solution was applied to glass by spin coating, was air-dried, was dried at 80° C. in vacuo, and thereby yielded a polysulfobutylbenzimidazole electrolyte membrane having a thickness of 45 μm. The polymer electrolyte membrane had an ionic conductivity at room temperature of 0.09 S/cm. The polymer electrolyte membrane was immersed in a 40 percent by weight aqueous methanol solution at 60° C. for seventy-two hours, was dried under reduced pressure, and was weighed. The polymer electrolyte membrane showed substantially no difference in dry weight between before and after immersion and was found to be insoluble in methanol.

In addition, the polymer electrolyte membrane was immersed in a Fenton's reagent at a temperature of 60° C. for twenty-four hours, was washed with water, was dried under reduced pressure, and the weight and ionic conductivity of the membrane were measured. The polymer electrolyte membrane showed substantially no difference in weight and ionic conductivity between before and after immersion to find to be satisfactorily resistant to oxidation. The Fenton's reagent contained 1.9 mg of ferrous sulfate heptahydrate in 20 ml of a 30% aqueous hydrogen peroxide solution.

### (4) Preparation of Membrane Electrode Assemblies (MEAs))

A membrane electrode assembly (MEA) (5) having a structure as shown in FIG. 3 was prepared in the following manner. Initially, a slurry was prepared by mixing a catalyst powder, 30 percent by weight of the polysulfomethylbenzimidazole electrolyte prepared in the step (1), and a solvent mixture of 1-propanol, 2-propanol, and methoxyethanol. The catalyst powder used herein contained a carbon carrier and 50 percent by weight of fine particles of a platinum/ruthenium alloy dispersed and supported on the carbon carrier, which alloy has an atomic ratio of platinum to ruthenium of 1:1.

The slurry was applied to a polyimide film by screen printing and thereby yielded an anode having a thickness of about 125 μm, a width of 30 mm, and a length of 30 mm.

Next, another slurry was prepared by mixing a catalyst powder, a binder, and a solvent mixture of water and alcohol. The catalyst powder contained a carbon carrier and 30 percent by weight of platinum fine particles supported on the carbon carrier. The binder was a solution of a poly(perfluorosulfonic acid) in a solvent mixture of 1-propanol, 2-propanol, and methoxyethanol. The slurry was applied to a polyimide film by screen printing and thereby yielded a cathode having a thickness of about 20 μm, a width of 30 mm, and a length of 30 mm.

Next, about 0.5 ml of a solution was allowed to permeate the surface of the anode. The solution was a 5 percent by weight solution of the polysulfomethylbenzimidazole electrolyte prepared in the step (1) in a solvent mixture of 1-propanol, 2-propanol, and methoxyethanol. The anode was then bonded with one side of the polysulfobutylbenzimidazole electrolyte membrane prepared in the step (3), and the article was dried at 80° C. under a load of 1 kg for three hours.

Next, about 0.5 ml of another solution was allowed to permeate the surface of the cathode. The solution was a 5 percent by weight solution of the polysulfomethylbenzimidazole electrolyte prepared in the step (2) in a solvent mixture of 1-propanol, 2-propanol, and methoxyethanol. The cathode was bonded with the other side of the polysulfomethylbenzimidazole electrolyte membrane opposite to the anode layer, so that the cathode layer overlay the anode layer with the interposition of the membrane. The resulting article was dried at 80° C. under a load of about 1 kg for three hours and thereby yielded the membrane electrode assembly (MEA) (5).

In addition, a membrane electrode assembly (MEA) (6) having a structure as shown in FIG. 3 was prepared by the procedure above, except for using the polysulfomethylbenzimidazole prepared in the step (2) and having a structural unit represented by Chemical Formula 24, instead of the polysulfomethylbenzimidazole electrolyte prepared in the step (1).

### (5) Generation Performance of Fuel Cells (Direct-Methanol Fuel Cells (DMFCs))

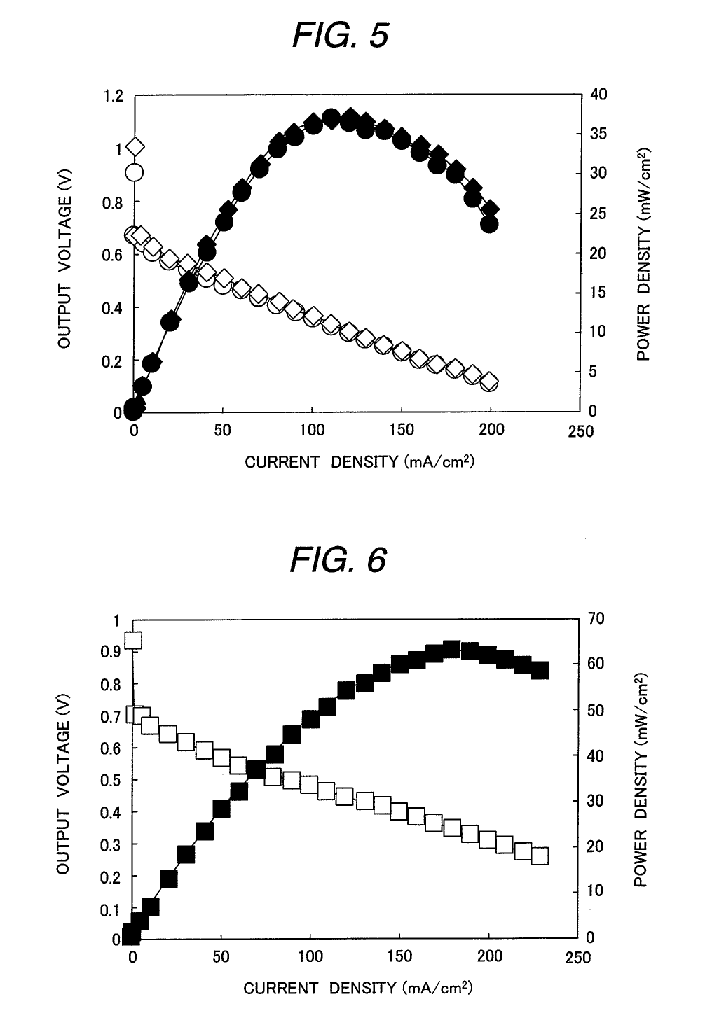

Each of the membrane electrode assemblies (MEAs) (5) and (6) bearing the diffusion layers was mounted to a single cell of solid polymer fuel cell generator having a structure as shown in FIG. 2, and the cell performance thereof was determined. FIG. 5 shows how the output voltages of the fuel cells vary depending on the current density. In FIG. 5, data indicated by the open rhombus ( [symbol] ) and open circle (◯) represent the data on the relationship between the output voltage and the current density of the membrane electrode assemblies (MEAs) (5) and (6), respectively; and data indicated by the filled rhombus ( [symbol] ) and filled circle (♦) represent data on the relationship between the power density and the current density of the membrane electrode assemblies (MEAs) (5) and (6), respectively.

The membrane electrode assemblies (MEAs) (5) and (6) showed output voltages under a load at a current density of 50 mA/cm² of 0.48 V and 0.51 V, respectively, and showed highest power densities of 37 mW/cm² and 37.2 mW/cm², respectively. After 4000-hour operation under a load at a current density of 50 mA/cm², they showed output voltages of 0.45 V and 0.48 V, respectively, which are 90% or more of the initial output voltages. These results demonstrate that the fuel cells can operate stably over extended periods of time.

### EXAMPLE 3

### (1) Preparation of Polyhydroxybenzimidazole

In 200 ml of sulfolane were dissolved 5.175 g (37.5 mmol) of 3,3′,4,4′-tetraaminobenzene and 13.137 g (37.5 mmol) of diphenyl 2,5-dihydroxyisophthalate in a three-neck flask equipped with a stirrer and a nitrogen feed tube, and oxygen in the flask was removed by feeding nitrogen gas thereto. The mixture was heated under reflux in an atmosphere of nitrogen gas flow for ninety-six hours, was cooled at room temperature, and was poured into a mixture containing 1 liter of methanol and 0.5 liter of acetone. The precipitates were filtered, were sequentially washed with distilled water and acetone, were dried, and thereby yielded a polyhydroxybenzimidazole having a structural unit represented by Chemical Formula 25:

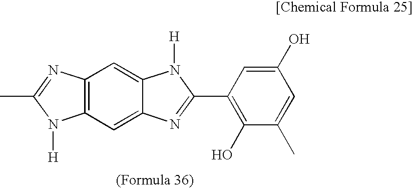

### (2) Preparation of Polysulfopropoxybenzimidazole

In 87 g of N-methylpyrrolidone was dissolved 8.23 g of the above-prepared polyhydroxybenzimidazole having a structural unit represented by Chemical Formula 25 under flow of nitrogen gas. The solution was combined with 10 g of a solution of sodium ethoxide in ethanol with stirring. The reaction mixture was further combined with 8.97 g of propane sultone added dropwise. After the completion of dropwise addition, the mixture was kept to 80° C. for three hours. The mixture was then cooled and was poured into a mixture containing 1 liter of methanol and 0.5 liter of acetone. The precipitates were filtered, were sequentially washed with distilled water and acetone, were dried, and thereby yielded a polysulfopropoxybenzimidazole having a structural unit represented by Chemical Formula 26:

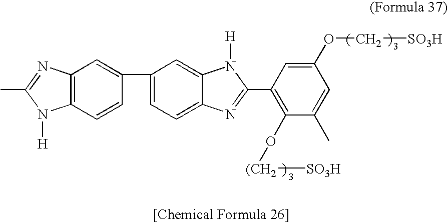

### (3) Preparation of Polymer Electrolyte Membrane and Evaluation Thereof

The polysulfopropoxybenzimidazole prepared in the step (2) and having a structural unit represented by Chemical Formula 26 was dissolved in N-methylpyrrolidone to yield a 5 percent by weight solution. The solution was applied to glass by spin coating, was air-dried, was dried at 80° C. in vacuo and thereby yielded a polysulfobutoxybenzimidazole electrolyte membrane having a thickness of 45 μm. The polymer electrolyte membrane had an ionic conductivity at room temperature of 0.17 S/cm. The polysulfopropoxybenzimidazole electrolyte membrane was immersed in a 40 percent by weight aqueous methanol solution at 60° C. for seventy-two hours, was dried under reduced pressure, and was weighed. The polymer electrolyte membrane showed substantially no difference in dry weight between before and after immersion and was found to be insoluble in methanol. In addition, the polymer electrolyte membrane was immersed in a Fenton's reagent at a temperature of 60° C. for twenty-four hours, was washed with water, was dried under reduced pressure, and the weight and ionic conductivity of the membrane were measured. The electrolyte membrane showed substantially no difference in weight and ionic conductivity between before and after immersion to find to be satisfactorily resistant to oxidation. The Fenton's reagent contained 1.9 mg of ferrous sulfate heptahydrate in 20 ml of a 30% aqueous hydrogen peroxide solution.

### (4) Preparation of Membrane Electrode Assembly (MEA)

A membrane electrode assembly (MEA) (7) having a structure as shown in FIG. 3 was prepared in the following manner. Initially, a slurry was prepared by mixing a catalyst powder, 30 percent by weight of the polysulfopropoxybenzimidazole electrolyte prepared in the step (2), and a solvent mixture of 1-propanol, 2-propanol, and methoxyethanol. The catalyst powder used herein contained a carbon carrier and 50 percent by weight of fine particles of a platinum/ruthenium alloy dispersed and supported on the carbon carrier, which alloy has an atomic ratio of platinum to ruthenium of 1:1.

The slurry was applied to a polyimide film by screen printing and thereby yielded an anode having a thickness of about 125 μm, a width of 30 mm, and a length of 30 mm. Next, another slurry was prepared by mixing a catalyst powder, a binder and a solvent mixture of water and alcohols. The catalyst powder contained a carbon carrier and 30 percent by weight of platinum fine particles supported on the carbon carrier. The binder was a solution of a poly(perfluorosulfonic acid) in a solvent mixture of 1-propanol, 2-propanol, and methoxyethanol. The slurry was applied to a polyimide film by screen printing and thereby yielded a cathode having a thickness of about 20 μm, a width of 30 mm, and a length of 30 mm.

About 0.5 ml of a solution was allowed to permeate the surface of the anode. The solution was a 5 percent by weight solution of the poly-sulfobutoxy-benzimidazole electrolyte prepared in the step (2) in a solvent mixture of 1-propanol, 2-propanol, and methoxyethanol. The anode was then bonded with one side of the polysulfopropoxybenzimidazole electrolyte membrane prepared in the step (3), and the article was dried at 80° C. under a load of 1 kg for three hours. Next, about 0.5 ml of another solution was allowed to permeate the surface of the cathode. The solution was a 5 percent by weight solution of the polysulfopropoxybenzimidazole electrolyte prepared in the step (2) in a solvent mixture of 1-propanol, 2-propanol, and methoxyethanol.

The cathode was bonded with the other side of the polysulfopropoxybenzimidazole electrolyte membrane opposite to the anode layer, so that the cathode layer overlay the anode layer with the interposition of the membrane. The resulting article was dried at 80° C. under a load of about 1 kg for three hours and thereby yielded the membrane electrode assembly (MEA) (7).

### (5) Generation Performance of Fuel Cell (Direct-Methanol Fuel Cell (DMFC))

The membrane electrode assembly (MEA) (7) bearing the diffusion layers was mounted to a single cell of a solid polymer fuel cell generator having a structure as shown in FIG. 2, and the cell performance thereof was determined. FIG. 6 shows how the output voltage of the fuel cell varies depending on the current density. In FIG. 6, data indicated by the open square (□) and filled square (▪) represent data on the relationship between the output voltage and the current density and those on the relationship between the power density and the current density of the fuel cell, respectively. The cell had an output voltage under a load at a current density of 50 mA/cm of 0.54 V and showed a highest power density of 63 mW/cm².

After 4000-hour operation under a load at a current density of 50 mA/cm², the cell had an output voltage of 0.52 V, about 90% or more of the initial output voltage. Thus, the cell was found to operate stably over extended periods of time.

### COMPARATIVE EXAMPLE 1

### (1) Preparation of Plysulfobutylbenzimidazole

In 87 g of N-methylpyrrolidone was dissolved 9.62 g of poly-2,2′-(m-phenylene)-5,5′-bibenzimidazole in a three-neck flask equipped with a stirrer and a nitrogen feed tube under flow of nitrogen gas. Next, the solution was combined with 0.6 g of lithium hydride and was kept to a temperature of 70° C. for twelve hours. After the completion of bubbling, 9 g of butanesultone was gradually added dropwise. The mixture was kept to 70° C. for twelve hours, was cooled, and was poured into a mixture containing 1 liter of methanol and 0.5 liter of acetone. The precipitates of polymer were filtered, were sequentially washed with distilled water and acetone, were dried, and thereby yielded a polysulfobutylbenzimidazole having a structural unit represented by Chemical Formula 27:

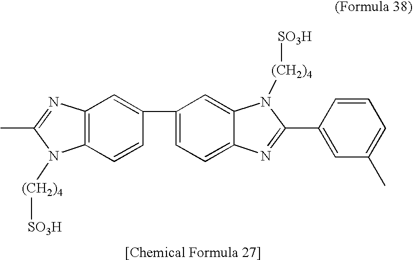

### (2) Preparation of Polysulfobutylbenzimidazole Electrolyte Membrane and Evaluation Thereof

The polysulfobutylbenzimidazole prepared in the step (1) and having a structural unit represented by Chemical Formula 27 was dissolved in N-methylpyrrolidone to yield a 5 percent by weight solution. The solution was applied to glass by spin coating, was air-dried, was dried at 80° C. in vacuo, and thereby yielded a polysulfobutylbenzimidazole electrolyte membrane having a thickness of 45 μm. The polymer electrolyte membrane had an ionic conductivity at room temperature of 0.008 S/cm. The above-prepared electrolyte membranes according to Examples 1 to 3 have ionic conductivities higher than that of the polysulfobutylbenzimidazole electrolyte membrane according to Comparative Example 1, and they are found to be suitable for use in fuel cells.

In addition, the electrolyte membrane according to Comparative Example 1 was immersed in a Fenton's reagent at a temperature of 60° C. for twenty-four hours, was washed with water, was dried under reduced pressure, and the weight and ionic conductivity of the membrane were measured. The oxidation resistance of the membrane was evaluated based on retentions in weight and ionic conductivity between before and after immersion, to find that the membrane showed low retentions in weight and ionic conductivity of 85% and 70% of the initial values, respectively, and has poor oxidation resistance. The Fenton's reagent contained 1.9 mg of ferrous sulfate heptahydrate in 20 ml of a 30% aqueous hydrogen peroxide solution.

### (3) Preparation of Membrane Electrode Assembly (MEA)

A membrane electrode assembly (MEA) (8) having a structure as shown in FIG. 3 was prepared in the following manner. Initially, a slurry was prepared by mixing a catalyst powder, 30 percent by weight of a binder, and a solvent mixture of water and alcohols (a 20:40:40 (by weight) solvent mixture of water, isopropyl alcohol, and n-propanol). The catalyst powder used herein contained a carbon carrier and 50 percent by weight of fine particles of a platinum/ruthenium alloy dispersed and supported on the carbon carrier, which alloy has an atomic ratio of platinum to ruthenium of 1:1.

The binder was a poly(perfluorosulfonic acid) electrolyte. The slurry was applied to a polyimide film by screen printing and thereby yielded an anode having a thickness of about 125 μm, a width of 30 mm, and a length of 30 mm. Next, another slurry was prepared by mixing a catalyst powder, 30 percent by weight of a poly(perfluorosulfonic acid) as a binder, and a solvent mixture of water and alcohols. The catalyst powder contained a carbon carrier and 30 percent by weight of platinum fine particles supported on the carbon carrier. The slurry was applied to a polyimide film by screen printing and thereby yielded a cathode having a thickness of about 20 μm, a width of 30 mm, and a length of 30 mm. About 0.5 ml of a solution was allowed to permeate the surface of the anode.

The solution was a 5 percent by weight solution of a poly (perfluorosulfonic acid) in a solvent mixture of water and alcohols (a 20:40:40 (by weight) solvent mixture of water, isopropyl alcohol, and n-propanol). The anode was then bonded with one side of the polysulfobutylbenzimidazole electrolyte membrane prepared in the step (2), and the article was dried at 80° C. under a load of 1 kg for three hours. Next, about 0.5 ml of another solution was allowed to permeate the surface of the cathode. The solution was a 5 percent by weight solution of a poly (perfluorosulfonic acid) in a solvent mixture of 1-propanol, 2-propanol, and methoxyethanol.

The cathode was bonded with the other side of the polymer electrolyte membrane opposite to the anode layer, so that the cathode layer overlay the anode layer with the interposition of the membrane. The resulting article was dried at 80° C. under a load of about 1 kg for three hours and thereby yielded the membrane electrode assembly (MEA) (8).

### (4) Generation Performance of Fuel Cell (Direct-Methanol Fuel Cell (DMFC))

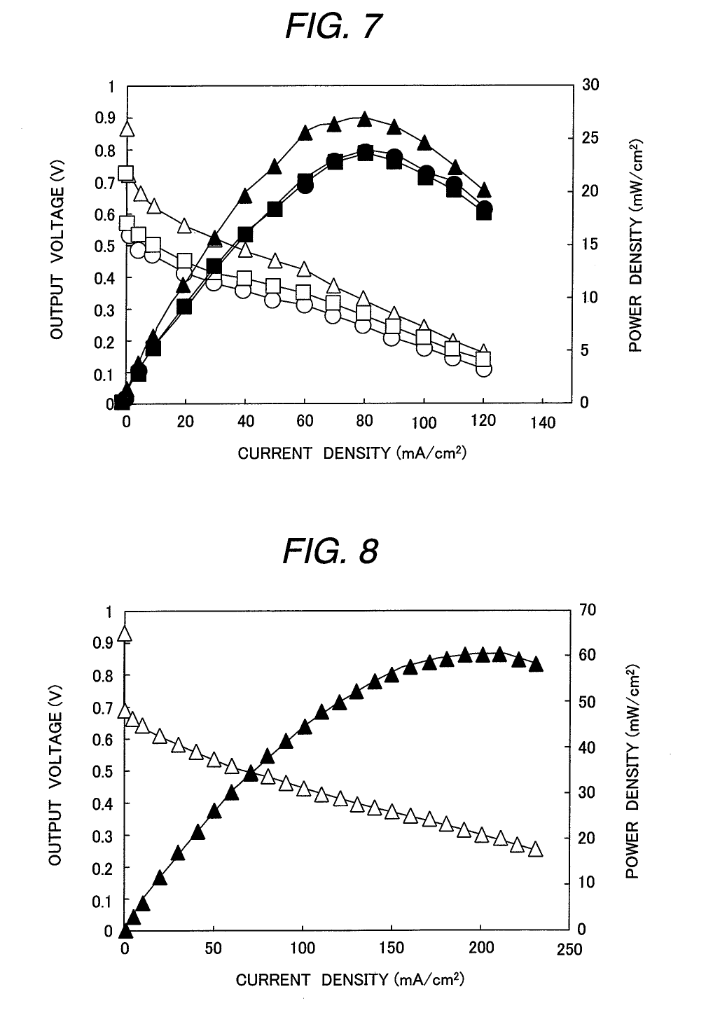

The membrane electrode assembly (MEA) (8) bearing the diffusion layers was mounted to a single cell of a solid polymer fuel cell generator having a structure as shown in FIG. 2, and the cell performance thereof was determined. FIG. 7 shows how the output voltage of the fuel cell varies depending on the current density. In FIG. 7, data indicated by the open square (□) and filled square (▪) represent data on the relationship between the output voltage and the current density and those on the relationship between the power density and the current density of the fuel cell, respectively.

The cell had an output voltage under a load at a current density of 50 mA/cm² of 0.37 V. After 4000-hour operation under a load at a current density of 50 mA/cm², the cell had an output voltage of 0.25 V.

These results show that hydrocarbon electrolyte membranes according to an embodiment of the present invention have ionic conductivities higher than that of a polysulfoalkylbenzimidazole hydrocarbon electrolyte membrane in related art and are suitable for use in fuel cells.

### COMPARATIVE EXAMPLE 2

### (1) Preparation of Polysulfobenzimidazole

In a three-neck flask equipped with a stirrer and a nitrogen feed tube were placed 8.035 g (37.5 mmol) of 3,3′,4,4′-tetraaminobiphenyl, 9.645 g (37.5 mmol) of 2,5-dicarboxybenzenesulfonic acid monosodium salt, 110 g of polyphosphoric acid (phosphorus pentoxide content: 75%), and 87.9 g of phosphorus pentoxide. The mixture was gradually raised in temperature to 100° C. under flow of nitrogen gas, was kept to 100° C. for one and a half hours, was raised in temperature to 150° C., and was kept to 150° C. for one hour. Next, the mixture was raised in temperature to 200° C. and was kept to 200° C. for four hours.

After cooling to room temperature, the mixture was combined with water, the contents were taken out, were pulverized in a mixer, and were washed with water repeatedly until the filtrate became neutral on a pH indicator paper. The resulting polymer was dried under reduced pressure and thereby yielded a polysulfobenzimidazole having a structural unit represented by Chemical Formula 28:

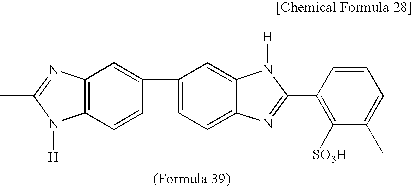

### (2) Preparation of Polysulfobenzimidazole Electrolyte Membrane and Evaluation Thereof

The polysulfobenzimidazole prepared in the step (1) and having a structural unit represented by Chemical Formula 28 was dissolved in N-methylpyrrolidone to yield a 5 percent by weight solution. The solution was applied to glass by spin coating, was air-dried, was dried at 80° C. in vacuo, and thereby yielded a polysulfobenzimidazole electrolyte membrane having a thickness of 45 μm. The polymer electrolyte membrane had an ionic conductivity at room temperature of 0.01 S/cm. The above-prepared electrolyte membranes according to Examples 1 to 3 have ionic conductivities higher than that of the polysulfobenzimidazole electrolyte membrane according to Comparative Example 2, and they are found to be suitable for use in fuel cells.

In addition, the electrolyte membrane according to Comparative Example 2 was immersed in a Fenton's reagent at a temperature of 60° C. for twenty-four hours, was washed with water, was dried under reduced pressure, and the weight and ionic conductivity of the membrane were measured. The membrane showed low retentions in weight and ionic conductivity of 45% and 25% of the initial values, respectively, and was found to have poor oxidation resistance. The Fenton's reagent contained 1.9 mg of ferrous sulfate heptahydrate in 20 ml of a 30% aqueous hydrogen peroxide solution.

### (3) Preparation of Membrane Electrode Assembly (MEA)

A membrane electrode assembly (MEA) (9) having a structure as shown in FIG. 3 was prepared in the following manner. Initially, a slurry was prepared by mixing a catalyst powder, 30 percent by weight of a poly(perfluorosulfonic acid) electrolyte as a binder, and a solvent mixture of water and alcohols (a 20:40:40 (by weight) solvent mixture of water, isopropyl alcohol, and n-propanol). The catalyst powder used herein contained a carbon carrier and 50 percent by weight of fine particles of a platinum/ruthenium alloy dispersed and supported on the carbon carrier, which alloy has an atomic ratio of platinum to ruthenium of 1:1.

The slurry was applied to a polyimide film by screen printing and thereby yielded an anode having a thickness of about 125 μm, a width of 30 mm, and a length of 30 mm. Next, another slurry was prepared by mixing a catalyst powder, 30 percent by weight of a poly(perfluorosulfonic acid) as a binder, and a solvent mixture of water and alcohols. The catalyst powder contained a carbon carrier and 30 percent by weight of platinum fine particles supported on the carbon carrier. The slurry was applied to a polyimide film by screen printing and thereby yielded a cathode having a thickness of about 20 μm, a width of 30 mm, and a length of 30 mm. About 0.5 ml of a solution was allowed to permeate the surface of the anode.

The solution was a 5 percent by weight solution of a poly(perfluorosulfonic acid) in a solvent mixture of water and alcohols (a 20:40:40 (by weight) solvent mixture of water, isopropyl alcohol, and n-propanol). The anode was then bonded with one side of the polysulfobenzimidazole electrolyte membrane prepared in the step (2) and was dried at 80° C. under a load of 1 kg for three hours. Next, about 0.5 ml of another solution was allowed to permeate the surface of the cathode. The solution was a 5 percent by weight solution of a poly(perfluorosulfonic acid) in a solvent mixture of 1-propanol, 2-propanol, and methoxyethanol.

The cathode was bonded with the other side of the polymer electrolyte membrane opposite to the anode layer so that the cathode layer overlay the anode layer with the interposition of the membrane. The resulting article was dried at 80° C. under a load of about 1 kg for three hours and thereby yielded the membrane electrode assembly (MEA) (9).

### (4) Generation Performance of Fuel Cell (Direct-Methanol Fuel Cell (DMFC))

The membrane electrode assembly (MEA) (9) bearing the diffusion layers was mounted to a single cell of a solid polymer fuel cell generator having a structure as shown in FIG. 2, and the cell performance thereof was determined. FIG. 7 shows how the output voltage of the fuel cell varies depending on the current density. In FIG. 7, data indicated by the open circle (◯) and filled circle () represent data on the relationship between the output voltage and the current density and those on the relationship between the power density and the current density of the fuel cell, respectively. The cell had an output voltage under a load at a current density of 50 mA/cm² of 0.32 V. After 4000-hour operation under a load at a current density of 50 mA/cm², the cell had an output voltage of 0.13 V, about 50% of the initial output voltage.

These results show that hydrocarbon electrolyte membranes according to an embodiment of the present invention have ionic conductivities higher than and are more durable than the polysulfobenzimidazole hydrocarbon electrolyte membrane in related art, and are suitable for use in fuel cells.

### COMPARATIVE EXAMPLE 3

### (1) Preparation of Polymer Electrolyte Membrane and Evaluation Thereof

The polyhydroxybenzimidazole electrolyte prepared in the step (1) of Example 3 and having a structural unit represented by Chemical Formula 20 was dissolved in N-methylpyrrolidone to yield a 5 percent by weight solution. The solution was applied to glass by spin coating, was air-dried, was dried at 80° C. in vacuo, and thereby yielded a polyhydroxy benzimidazole electrolyte membrane having a thickness of 45 μm. The polymer electrolyte membrane had an ionic conductivity at room temperature of 0.003 S/cm, lower than those of the electrolyte membranes according to Examples 1 to 3. This indicates that the electrolyte membranes according to an embodiment of the present invention are suitable for use in fuel cells. The polyhydroxybenzimidazole electrolyte membrane was immersed in a 40 percent by weight aqueous methanol solution at 60° C. for seventy-two hours, was dried under reduced pressure, and was weighed. The polymer electrolyte membrane showed substantially no difference in dry weight between before and after immersion and was found to be insoluble in methanol. In addition, the polymer electrolyte membrane was immersed in a Fenton's reagent at a temperature of 60° C. for one, was washed with water, was dried under reduced pressure, and the weight and ionic conductivity of the membrane were measured. The Fenton's reagent contained 1.9 mg of ferrous sulfate heptahydrate in 20 ml of a 30% aqueous hydrogen peroxide solution. The membrane showed low retentions in weight and ionic conductivity of 45% and 40% of the initial values, respectively, and was found to have poor oxidation resistance. This result demonstrate that the electrolyte membranes according to Examples 1 to 3 have higher oxidation resistance than that of the membrane according to Comparative Example 3.

### (2) Preparation of Membrane Electrode Assembly (MEA)

A membrane electrode assembly (MEA) (10) having a structure as shown in FIG. 3 was prepared in the following manner. Initially, a slurry was prepared by mixing a catalyst powder, 5 percent by weight of a poly(perfluorosulfonic acid) electrolyte, and a solvent mixture of 1-propanol, 2-propanol, and methoxyethanol. The catalyst powder used herein contained a carbon carrier and 50 percent by weight of fine particles of a platinum/ruthenium alloy dispersed and supported on the carbon carrier, which alloy has an atomic ratio of platinum to ruthenium of 1:1.

The slurry was applied to a polyimide film by screen printing and thereby yielded an anode having a thickness of about 125 μm, a width of 30 mm, and a length of 30 mm. Next, another slurry was prepared by mixing a catalyst powder, a binder, and a solvent mixture of water and alcohols. The catalyst powder contained a carbon carrier and 30 percent by weight of platinum fine particles supported on the carbon carrier. The binder was a 5 percent by weight solution of a poly(perfluorosulfonic acid) in a solvent mixture of 1-propanol, 2-propanol, and methoxyethanol. The slurry was applied to a polyimide film by screen printing and thereby yielded a cathode having a thickness of about 20 μm, a width of 30 mm, and a length of 30 mm. About 0.5 ml of a solution was allowed to permeate the surface of the anode. This solution was a 5 percent by weight solution of a poly(perfluorosulfonic acid) electrolyte in a solvent mixture of 1-propanol, 2-propanol, and methoxyethanol.

The anode was then bonded with one side of the polyhydroxybenzimidazole electrolyte membrane and was dried at 80° C. under a load of 1 kg for three hours. Next, about 0.5 ml of another solution was allowed to permeate the surface of the cathode. This solution was a 5 percent by weight solution of a poly(perfluorosulfonic acid) electrolyte in a solvent mixture of 1-propanol, 2-propanol, and methoxyethanol. The cathode was then bonded with the other side of the polyhydroxybenzimidazole electrolyte membrane opposite to the anode layer, so that the cathode layer overlay the anode layer with the interposition of the membrane. The article was dried at 80° C. under a load of about 1 kg for three hours and thereby yielded the membrane electrode assembly (MEA) (10).

### (3) Generation Performance of Fuel Cell (Direct-Methanol Fuel Cell (DMFC))

The membrane electrode assembly (MEA) (10) bearing the diffusion layers was mounted to a single cell of a solid polymer fuel cell generator having a structure as shown in FIG. 2, and the cell performance thereof was determined. FIG. 7 shows how the output voltage of the fuel cell varies depending on the current density. In FIG. 7, data indicated by the open triangle ( [symbol] ) and filled triangle (▴) represent data on the relationship between the output voltage and the current density and those on the relationship between the power density and the current density of the fuel cell, respectively. The cell had an output voltage under a load at a current density of 50 mA/cm of 0.45 V. After 4000-hour operation under a load at a current density of 50 mA/cm², the cell showed no output.

These results show that the hydrocarbon electrolyte membranes according to Examples 1 to 3 have ionic conductivities higher and are more durable than the polysulfobenzimidazole hydrocarbon electrolyte membrane in related art, and are suitable for use in fuel cells.

### EXAMPLE 4

### (1) Preparation of 3,3′-bis(trimethylsiloxy)-4,4′-bis(trimethylsilylamino)biphenyl

In 80 ml of dry tetrahydrofuran were dissolved 4.32 g (20 mmol) of 4,4′-diamino-3,3′-dihydroxybiphenyl and 8.50 g of (84 mmol) of triethylamine in a three-neck flask equipped with a stirrer, a nitrogen feed tube, and a calcium chloride tube. To the solution was gradually added dropwise 9.12 g (84 mmol) of trimethylsilyl chloride with stirring at a temperature of 20° C. The mixture was stirred at 20° C. for one hour and was further stirred at 60° C. for four hours. The resulting triethylamine hydrochloride was filtered in a nitrogen atmosphere. In addition, a fraction at 200° C. to 230° C. at 0.5 Torr was separated. Next, recrystallization from ligroin was carried out to thereby yield 3,3′-bis(trimethylsiloxy)-4,4′-bis(trimethylsilylamino)biphenyl represented by following Chemical Formula 29:

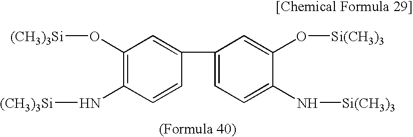

### (2) Preparation of Polysulfohexamethylenebenzoxazole

In 5 ml of N,N′-dimethylformamide was dissolved 1.263 g (2.5 mmol) of 3,3′-bis(trimethylsiloxy)-4,4′-bis(trimethylsilylamino)biphenyl in a three-neck flask equipped with a stirrer and a nitrogen feed tube. The solution was solidified on a dry ice-acetone bath. This was combined with 1.33 g (2.5 mmol) of 2,5-disulfosulfohexamethylene-isophthaloyl chloride added in one step, the bath was changed to a water bath, and the mixture was stirred at 0° C. to 5° C. for eight hours. The contents were poured into 500 ml of methanol, were filtered, were washed, and were dried. This was kept to 25° C. under reduced pressure for thirty hours and thereby yielded a polysulfohexamethylenebenzoxazole having a structural unit represented by following Chemical Formula 30:

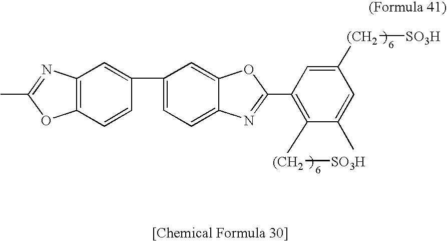

### (3) Preparation of Polymer Electrolyte Membrane and Evaluation Thereof

The polysulfohexamethylenebenzoxazole prepared in the step (2) and having a structural unit represented by Chemical Formula 30 was dissolved in N-methylpyrrolidone to yield a 5 percent by weight solution. The solution was applied to glass by spin coating, was air-dried, was dried at 80° C. in vacuo, and thereby yielded a polysulfohexamethylenebenzoxazole electrolyte membrane having a thickness of 45 μm. The polymer electrolyte membrane had an ionic conductivity at room temperature of 0.18 S/cm. The polymer electrolyte membrane was immersed in a 40 percent by weight aqueous methanol solution at 60° C. for seventy-two hours, was dried under reduced pressure, and was weighed.

The polymer electrolyte membrane showed substantially no difference in dry weight between before and after immersion and was found to be insoluble in methanol. In addition, the polymer electrolyte membrane was immersed in a 3 percent by weight aqueous hydrogen peroxide solution containing 20 ppm of ferric chloride at 80° C. for twenty-four hours, was washed with water, and was dried under reduced pressure. The membrane showed substantially no difference in weight and ionic conductivity between before and after immersion and was found to have good oxidation resistance.

### (4) Preparation of Membrane Electrode Assembly (MEA)

A membrane electrode assembly (MEA) (11) having a structure as shown in FIG. 3 was prepared in the following manner. Initially, a slurry was prepared by mixing a catalyst powder, 30 percent by weight of the polysulfohexamethylenebenzoxazole electrolyte prepared in the step (2), and a solvent mixture of 1-propanol, 2-propanol, and methoxyethanol. The catalyst powder used herein contained a carbon carrier and 50 percent by weight of fine particles of a platinum/ruthenium alloy dispersed and supported on the carbon carrier, which alloy has an atomic ratio of platinum to ruthenium of 1:1. The slurry was applied to a polyimide film by screen printing and thereby yielded an anode having a thickness of about 125 μm, a width of 30 mm, and a length of 30 mm. Next, another slurry was prepared by mixing a catalyst powder, a binder, and a solvent mixture of water and alcohols.

The catalyst powder contained a carbon carrier and 30 percent by weight of platinum fine particles supported on the carbon carrier. The binder was a solution of a poly(perfluorosulfonic acid) in a solvent mixture of 1-propanol, 2-propanol, and methoxyethanol. The slurry was applied to a polyimide film by screen printing and thereby yielded a cathode having a thickness of about 20 μm, a width of 30 mm, and a length of 30 mm. About 0.5 ml of a solution was allowed to permeate the surface of the anode. The solution was a 5 percent by weight solution of the polysulfohexamethylenebenzoxazole electrolyte prepared in the step (2) in a solvent mixture of 1-propanol, 2-propanol, and methoxyethanol.

The anode was then bonded with one side of the polysulfobutylbenzimidazole electrolyte membrane prepared in the step (3) and was dried at 80° C. under a load of 1 kg for three hours. Next, about 0.5 ml of another solution was allowed to permeate the surface of the cathode. The solution was a 5 percent by weight solution of the polysulfohexamethylenebenzoxazole electrolyte prepared in the step (2) in a solvent mixture of 1-propanol, 2-propanol, and methoxyethanol. The cathode was then bonded with the other side of the polysulfohexamethylenebenzoxazole electrolyte membrane opposite to the anode layer, so that the cathode layer overlay the anode layer with the interposition of the membrane. The resulting article was dried at 80° C. under a load of about 1 kg for three hours and thereby yielded the membrane electrode assembly (MEA) (11).

### (5) Generation Performance of Fuel Cell (Direct-Methanol Fuel Cell (DMFC))

The membrane electrode assembly (MEA) (11) bearing the diffusion layers was mounted to a single cell of a solid polymer fuel cell generator having a structure as shown in FIG. 2, and the cell performance thereof was determined. FIG. 8 shows how the output voltage of the fuel cell varies depending on the current density. In FIG. 8, data indicated by the open triangle ( [symbol] ) and filled triangle (▴) represent data on the relationship between the output voltage and the current density and those on the relationship between the power density and the current density of the fuel cell, respectively. The cell had an output voltage under a load at a current density of 50 mA/cm² of 0.54 V and showed a highest power density of 60 mW/cm². After 4000-hour operation under a load at a current density of 50 mA/cm², the cell had an output voltage of 0.53 V, about 90% or more of the initial output voltage, indicating that the cell can operate stably over extended periods of time.

### EXAMPLE 5

### (1) Preparation of 2,5-bis [(trimethoxycarbonyl)ethylthio]-1,4-phenylenediamine

In 300 ml of water was dissolved 21.6 g (0.54 mol) of sodium hydroxide in a three-neck flask equipped with a stirrer, a nitrogen feed tube, and a calcium chloride tube. In an atmosphere of nitrogen gas flow, 30.0 g (122 mmol) of 2,5-diamino-1,4′-benzenedithiol dihydrochloride was further dissolved in the solution. The resulting mixture was cooled to 5° C. and was combined with a solution of 29.4 ml (0.269 mol) of methyl 3-bromopropionate and 1.0 g (3.12 mmol) of triethylamine in 80 ml of dry tetrahydrofuran. The mixture was further combined with 9.12 g (84 mmol) of cetyltrimethylammonium chloride and was strongly stirred at a temperature of 5° C. for one hour and at room temperature for further four hours. The precipitates were filtered, were thoroughly washed with water, were dried, were recrystallized from hexane, and thereby yielded 2,5-bis [(trimethoxycarbonyl)ethylthio]-1,4-phenylenediamine.

### (2) Preparation of polysulfohexamethylenebenzothiazole

In 5 ml of N-methylpyrrolidone was dissolved 0.861 g (2.5 mmol) of 2,5-bis [(trimethoxycarbonyl)ethylthio]-1,4-phenylenediamine in a three-neck flask equipped with a stirrer and a nitrogen feed tube, and 1.33 g (2.5 mmol) of 2,5-bis (sulfosulfohexamethylene)-isophthaloyl chloride was added in one step at a temperature of 0° C.

Next, the mixture was stirred at room temperature for eight hours. The contents were poured into 500 ml of methanol, were filtered, were washed, were dried, and thereby yielded a polysulfohexamethylenebenzothiazole having a structure unit represented by following Chemical Formula 31:

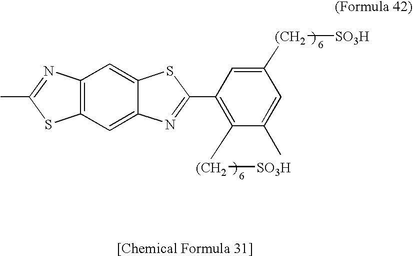

### (3) Preparation of Polymer Electrolyte Membrane and Evaluation Thereof

The polysulfohexamethylenebenzothiazole prepared in the step (2) and having a structural unit represented by Chemical Formula 31 was dissolved in N-methylpyrrolidone to yield a 5 percent by weight solution. The solution was applied to glass by spin coating, was air-dried, was dried at 80° C. in vacuo, and thereby yielded a polysulfohexamethylenebenzothiazole electrolyte membrane having a thickness of 45 μm. The polymer electrolyte membrane had an ionic conductivity at room temperature of 0.18 S/cm.

The polysulfohexamethylenebenzothiazole electrolyte membrane was immersed in a 40 percent by weight aqueous methanol solution at 60° C. for seventy-two hours, was dried under reduced pressure, and was weighed. The polymer electrolyte membrane showed substantially no difference in dry weight between before and after immersion and was found to be insoluble in methanol. In addition, the polymer electrolyte membrane was immersed in a Fenton's reagent at a temperature of 60° C. for twenty-four hours, was washed with water, was dried under reduced pressure, and the weight and ionic conductivity of the membrane were measured. The Fenton's reagent contained 1.9 mg of ferrous sulfate heptahydrate in 20 ml of a 30% aqueous hydrogen peroxide solution.

The oxidation resistance of the membrane was evaluated based on retentions in weight and ionic conductivity between before and after immersion. The polymer electrolyte membrane showed high retentions in weight and ionic conductivity and was found to have good oxidation resistance.

### (4) Preparation of Membrane Electrode Assembly (MEA)

A membrane electrode assembly (MEA) (12) having a structure as shown in FIG. 3 was prepared in the following manner. Initially, a slurry was prepared by mixing a catalyst powder, 30 percent by weight of the polysulfohexamethylenebenzothiazole electrolyte prepared in the step (2), and a solvent mixture of 1-propanol, 2-propanol, and methoxyethanol. The catalyst powder used herein contained a carbon carrier and 50 percent by weight of fine particles of a platinum/ruthenium alloy dispersed and supported on the carbon carrier, which alloy has an atomic ratio of platinum to ruthenium of 1:1.

The slurry was applied to a polyimide film by screen printing and thereby yielded an anode having a thickness of about 125 μm, a width of 30 mm, and a length of 30 mm. Next, another slurry was prepared by mixing a catalyst powder, a binder, and a solvent mixture of water and alcohols. The catalyst powder contained a carbon carrier and 30 percent by weight of platinum fine particles supported on the carbon carrier. The binder was a solution of a poly (perfluorosulfonic acid) in a solvent mixture of 1-propanol, 2-propanol, and methoxyethanol. The slurry was applied to a polyimide film by screen printing and thereby yielded a cathode having a thickness of about 20 μm, a width of 30 mm, and a length of 30 mm. About 0.5 ml of a solution was allowed to permeate the surface of the anode. The solution was a 5 percent by weight solution of the polysulfohexamethylenebenzothiazole electrolyte prepared in the step (2) in a solvent mixture of 1-propanol, 2-propanol, and methoxyethanol.

The anode was then bonded with one side of the polysulfohexamethylenebenzothiazole electrolyte membrane prepared in the step (3) and was dried at 80° C. under a load of 1 kg for three hours. Next, about 0.5 ml of another solution was allowed to permeate the surface of the cathode. The solution was a 5 percent by weight solution of the polysulfohexamethylenebenzothiazole electrolyte prepared in the step (2) in a solvent mixture of 1-propanol, 2-propanol, and methoxyethanol.

The cathode was then bonded with the other side of the polysulfohexamethylenebenzothiazole electrolyte membrane opposite to the anode layer, so that the cathode layer overlay the anode layer with the interposition of the membrane. The resulting article was dried at 80° C. under a load of about 1 kg for three hours and thereby yielded the membrane electrode assembly (MEA) (12).

### (5) Generation Performance of Fuel Cell (Direct-Methanol Fuel Cell (DMFC))

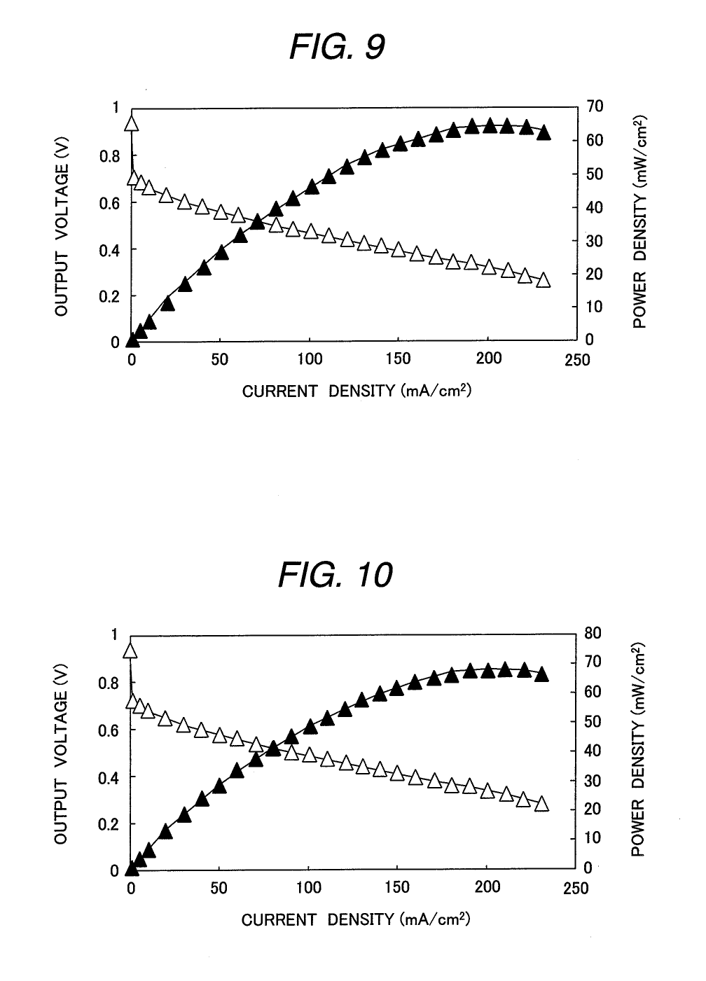

The membrane electrode assembly (MEA) (12) bearing the diffusion layers was mounted to a single cell of a solid polymer fuel cell generator having a structure as shown in FIG. 2, and the cell performance thereof was determined. FIG. 9 shows how the output voltage of the fuel cell varies depending on the current density. In FIG. 9, data indicated by the open triangle ( [symbol] ) and filled triangle (▴) represent data on the relationship between the output voltage and the current density and those on the relationship between the power density and the current density of the fuel cell, respectively. The cell had an output voltage under a load at a current density of 50 mA/cm² of 0.56 V and showed a highest power density of 65 mW/cm². After 4000-hour operation under a load at a current density of 50 mA/cm², the cell had an output voltage of 0.54 V, about 90% or more of the initial output voltage, indicating that the cell can operate stably over extended periods of time.

### EXAMPLE 6

### (1) Preparation of Polysulfoethylbenzimidazole

In a three-neck flask equipped with a stirrer and a nitrogen feed tube were placed 10.533 g (37.5 mmol) of 3,3′,4,4′-tetraaminodiphenyl sulfone, 15.573 g (37.5 mmol) of 2,5-dicarboxy-1,4-bissulfoethylbenzene disodium salt, 110 g of polyphosphoric acid (phosphorus pentoxide content: 75%), and 87.9 g of phosphorus pentoxide. The mixture was gradually raised in temperature to 100° C. under flow of nitrogen gas, was kept to 100° C. for one and a half hours, was raised in temperature to 150° C., and was kept to 150° C. for one hour. Next, the mixture was raised in temperature to 200° C. and was kept to 200° C. for four hours. After cooling to room temperature, the mixture was combined with water, the contents were taken out, were pulverized in a mixer, and were washed with water repeatedly until the filtrate became neutral on a pH indicator paper. The resulting polymer was dried under reduced pressure and thereby yielded a polysulfoethylbenzimidazole having a structural unit represented by Chemical Formula 32:

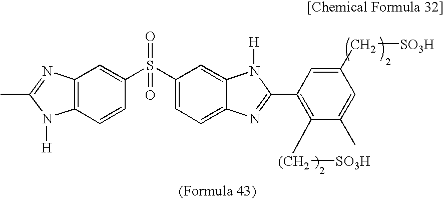

### (2) Preparation of Polymer Electrolyte Membrane and Evaluation Thereof

The polysulfoethylbenzimidazole prepared in the step (1) and having a structural unit represented by Chemical Formula 32 was dissolved in N-methylpyrrolidone to yield a 5 percent by weight solution. The solution was applied to glass by spin coating, was air-dried, was dried at 80° C. in vacuo, and thereby yielded a polysulfoethylbenzimidazole electrolyte membrane having a thickness of 45 μm. The polysulfoethylbenzimidazole electrolyte membrane had an ionic conductivity at room temperature of 0.10 S/cm. The polysulfoethylbenzimidazole electrolyte membrane was immersed in a 40 percent by weight aqueous methanol solution at 60° C. for seventy-two hours, was dried under reduced pressure, and was weighed. The polymer electrolyte membrane showed substantially no difference in dry weight between before and after immersion and was found to be insoluble in methanol. In addition, the polymer electrolyte membrane was immersed in a Fenton's reagent at a temperature of 60° C. for twenty-four hours, was washed with water, was dried under reduced pressure, and the weight and ionic conductivity of the membrane were measured. The Fenton's reagent contained 1.9 mg of ferrous sulfate heptahydrate in 20 ml of a 30% aqueous hydrogen peroxide solution. The polymer electrolyte membrane showed high retentions in weight and ionic conductivity and was found to have good oxidation resistance.

### (3) Preparation of Membrane Electrode Assembly (MEA)

A membrane electrode assembly (MEA) (13) having a structure as shown in FIG. 3 was prepared in the following manner. Initially, a slurry was prepared by mixing a catalyst powder, 30 percent by weight of the polysulfoethylbenzimidazole electrolyte prepared in the step (1), and a solvent mixture of 1-propanol, 2-propanol, and methoxyethanol. The catalyst powder used herein contained a carbon carrier and 50 percent by weight of fine particles of a platinum/ruthenium alloy dispersed and supported on the carbon carrier, which alloy has an atomic ratio of platinum to ruthenium of 1:1. The slurry was applied to a polyimide film by screen printing and thereby yielded an anode having a thickness of about 125 μm, a width of 30 mm, and a length of 30 mm.

Next, another slurry was prepared by mixing a catalyst powder, a binder, and a solvent mixture of water and alcohols. The catalyst powder contained a carbon carrier and 30 percent by weight of platinum fine particles supported on the carbon carrier. The binder was a solution of a poly(perfluorosulfonic acid) in a solvent mixture of 1-propanol, 2-propanol, and methoxyethanol.

The slurry was applied to a polyimide film by screen printing and thereby yielded a cathode having a thickness of about 20 μm, a width of 30 mm, and a length of 30 mm. About 0.5 ml of a solution was allowed to permeate the surface of the anode. The solution was a 5 percent by weight solution of the polysulfoethylbenzimidazole electrolyte prepared in the step (1) in a solvent mixture of 1-propanol, 2-propanol, and methoxyethanol.

The anode was then bonded with one side of the polysulfoethylbenzimidazole electrolyte membrane prepared in the step (2) and was dried at 80° C. under a load of 1 kg for three hours. Next, about 0.5 ml of another solution was allowed to permeate the surface of the cathode. The solution was a 5 percent by weight solution of the polysulfoethylbenzimidazole electrolyte prepared in the step (1) in a solvent mixture of 1-propanol, 2-propanol, and methoxyethanol.

The cathode was then bonded with the other side of the polysulfoethylbenzimidazole electrolyte membrane opposite to the anode layer, so that the cathode layer overlay the anode layer with the interposition of the membrane. The resulting article was dried at 80° C. under a load of about 1 kg for three hours and thereby yielded the membrane electrode assembly (MEA) (13).

### (4) Generation Performance of Fuel Cell (Direct-Methanol Fuel Cell (DMFC))

The membrane electrode assembly (MEA) (13) bearing the diffusion layers was mounted to a single cell of a solid polymer fuel cell generator having a structure as shown in FIG. 2, and the cell performance thereof was determined. FIG. 10 shows how the output voltage of the fuel cell varies depending on the current density. In FIG. 10, data indicated by the open triangle ( [symbol] ) and filled triangle (▴) represent data on the relationship between the output voltage and the current density and those on the relationship between the power density and the current density of the fuel cell, respectively.

The cell had an output voltage under a load at a current density of 50 mA/cm² of 0.53 V and showed a highest power density of 40 mW/cm². After 4000-hour operation under a load at a current density of 50 mA/cm², the cell had an output voltage of 0.50 V, about 90% or more of the initial output voltage, indicating that the cell can operate stably over extended periods of time.

### EXAMPLE 7

### (1) Preparation of Polyhydroxybenzimidazole

In 200 ml of sulfolane were dissolved 5.213 g (37.5 mmol) of 3,3′,4,4′-tetraaminopyridine and 13.137 g (37.5 mmol) of diphenyl 2,5-dihydroxyisophthalate in a three-neck flask equipped with a stirrer and a nitrogen feed tube, and oxygen in the flask was removed by feeding nitrogen gas thereto. The solution was heated under reflux in an atmosphere of nitrogen gas flow for ninety-six hours, was cooled at room temperature, and was poured into a mixture containing 1 liter of methanol and 0.5 liter of acetone. The precipitates were filtered, were sequentially washed with distilled water and acetone, were dried, and thereby yielded a polyhydroxybenzimidazole having a structural unit represented by Chemical Formula 33:

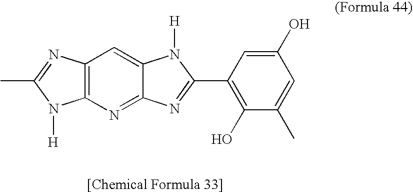

### (2) Preparation of Poly-Sulfobutoxy-Benzimidazole

The polyhydroxybenzimidazole having a structural unit of Chemical Formula 32 (10.6 g) was dissolved in 87 g of N-methylpyrrolidone under flow of nitrogen gas. The solution was combined with 10 g of a solution of sodium ethoxide in ethanol with stirring. The reaction mixture was combined with 10 g of butanesultone added dropwise. After the completion of dropwise addition, the mixture was kept to 80° C. for three hours. The reaction mixture was cooled and was poured into a mixture containing 1 liter of methanol and 0.5 liter of acetone. The precipitates were filtered, were sequentially washed with distilled water and acetone, were dried, and thereby yielded a poly-sulfobutoxy-benzimidazole having a structural unit represented by Chemical Formula 34:

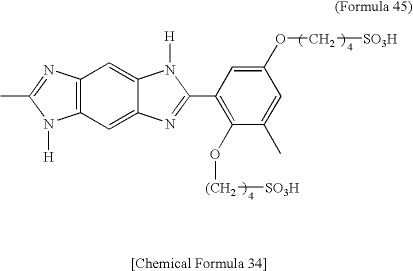

### (3) Preparation of Polymer Electrolyte Membrane and Evaluation Thereof

The poly-sulfobutoxy-benzimidazole prepared in the step (2) and having a structural unit represented by Chemical Formula 34 was dissolved in N-methylpyrrolidone to yield a 5 percent by weight solution. The solution was applied to glass by spin coating, was air-dried, was dried at 80° C. in vacuo, and thereby yielded a poly-sulfobutoxy-benzimidazole electrolyte membrane having a thickness of 45 μm.

The poly-sulfobutoxy-benzimidazole electrolyte membrane had an ionic conductivity at room temperature of 0.09 S/cm. The poly-sulfobutoxy-benzimidazole electrolyte membrane was immersed in a 40 percent by weight aqueous methanol solution at 60° C. for seventy-two hours, was dried under reduced pressure, and was weighed. The polymer electrolyte membrane showed substantially no difference in dry weight between before and after immersion and was found to be insoluble in methanol. In addition, the polymer electrolyte membrane was immersed in a Fenton's reagent at a temperature of 60° C. for twenty-four hours, was washed with water, was dried under reduced pressure, and the weight and ionic conductivity of the membrane were measured. The Fenton's reagent contained 1.9 mg of ferrous sulfate heptahydrate in 20 ml of a 30% aqueous hydrogen peroxide solution. The polymer electrolyte membrane showed high retentions in weight and ionic conductivity and was found to have good oxidation resistance.

### (4) Preparation of Membrane Electrode Assembly (MEA)

A membrane electrode assembly (MEA) (14) having a structure as shown in FIG. 3 was prepared in the following manner. Initially, a slurry was prepared by mixing a catalyst powder, 30 percent by weight of the poly-sulfobutoxy-benzimidazole electrolyte prepared in the step (2), and a solvent mixture of 1-propanol, 2-propanol, and methoxyethanol. The catalyst powder used herein contained a carbon carrier and 50 percent by weight of fine particles of a platinum/ruthenium alloy dispersed and supported on the carbon carrier, which alloy has an atomic ratio of platinum to ruthenium of 1:1. The slurry was applied to a polyimide film by screen printing and thereby yielded an anode having a thickness of about 125 μm, a width of 30 mm, and a length of 30 mm. Next, another slurry was prepared by mixing a catalyst powder, a binder, and a solvent mixture of water and alcohols.

The catalyst powder contained a carbon carrier and 30 percent by weight of platinum fine particles supported on the carbon carrier. The binder was a solution of a poly (perfluorosulfonic acid) in a solvent mixture of 1-propanol, 2-propanol, and methoxyethanol. The slurry was applied to a polyimide film by screen printing and thereby yielded a cathode having a thickness of about 20 μm, a width of 30 mm, and a length of 30 mm. About 0.5 ml of a solution was allowed to permeate the surface of the anode. The solution was a 5 percent by weight solution of the poly-sulfobutoxy-benzimidazole electrolyte prepared in the step (2) in a solvent mixture of 1-propanol, 2-propanol, and methoxyethanol. The anode was then bonded with one side of the poly-sulfobutoxy-benzimidazole electrolyte membrane prepared in the step (3) and was dried at 80° C. under a load of 1 kg for three hours. Next, about 0.5 ml of another solution was allowed to permeate the surface of the cathode.

The solution was a 5 percent by weight solution of the poly-sulfobutoxy-benzimidazole electrolyte prepared in the step (2) in a solvent mixture of 1-propanol, 2-propanol, and methoxyethanol. The cathode was then bonded with the other side of the poly-sulfobutoxy-benzimidazole electrolyte membrane opposite to the anode layer, so that the cathode layer overlay the anode layer with the interposition of the membrane. The resulting article was dried at 80° C. under a load of about 1 kg for three hours and thereby yielded the membrane electrode assembly (MEA) (14).

### (5) Generation Performance of Fuel Cell (Direct-Methanol Fuel Cell (DMFC))

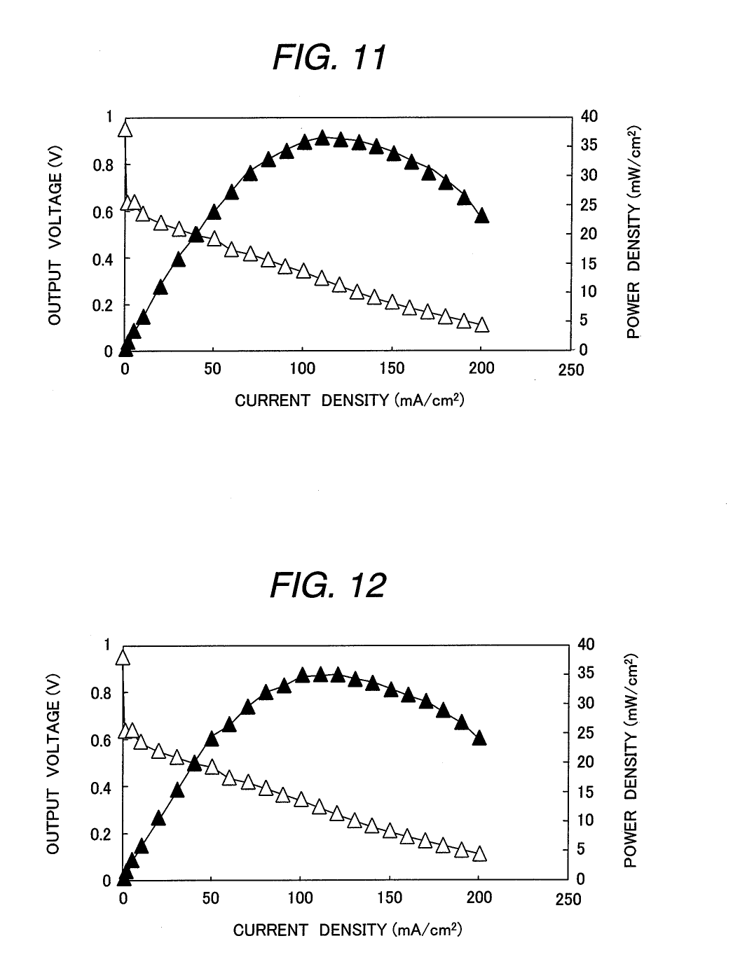

The membrane electrode assembly (MEA) (14) bearing the diffusion layers was mounted to a single cell of a solid polymer fuel cell generator having a structure as shown in FIG. 2, and the cell performance thereof was determined. FIG. 11 shows how the output voltage of the fuel cell varies depending on the current density. In FIG. 11, data indicated by the open triangle ( [symbol] ) and filled triangle (▴) represent data on the relationship between the output voltage and the current density and those on the relationship between the power density and the current density of the fuel cell, respectively. The cell had an output voltage under a load at a current density of 50 mA/cm² of 0.48 V and showed a highest power density of 36 mW/cm². After 4000-hour operation under a load at a current density of 50 mA/cm², the cell had an output voltage of 0.44 V, about 90% or more of the initial output voltage, indicating that the cell can operate stably over extended periods of time.

### EXAMPLE 8

### (1) Preparation of Polysulfomethylbenzimidazole

In a three-neck flask equipped with a stirrer and a nitrogen feed tube were placed 8.035 g (37.5 mmol) of 3,3′,4,4′-tetraaminobiphenyl, 6.78 g (25.0 mmol) of 2,5-dicarboxy-1,4-sulfomethylbenzene monosodium salt, 2.075 g (12.5 mmol) of 2,5-dicarboxybenzene, 110 g of polyphosphoric acid (phosphorus pentoxide content: 75%), and 87.9 g of phosphorus pentoxide. The mixture was gradually raised in temperature to 100° C. under flow of nitrogen gas, was kept to 100° C. for one and a half hours, was raised in temperature to 150° C., and was kept to 150° C. for one hour.

Next, the mixture was raised in temperature to 200° C. and was kept to 200° C. for four hours. After cooling to room temperature, the mixture was combined with water, the contents were taken out, were pulverized in a mixer, and were washed with water repeatedly until the filtrate became neutral on a pH indicator paper. The resulting polymer was dried under reduced pressure and thereby yielded a polysulfomethylbenzimidazole having a structural unit represented by Chemical Formula 35:

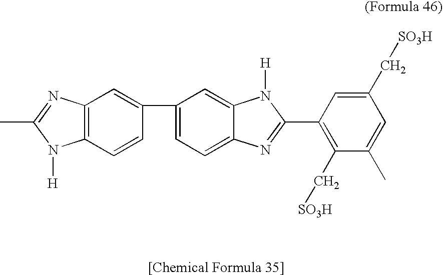

### (2) Preparation of Polymer Electrolyte Membrane and Evaluation Thereof

The polysulfomethylbenzimidazole prepared in the step (1) and having a structural unit represented by Chemical Formula 35 was dissolved in N-methylpyrrolidone to yield a 5 percent by weight solution. The solution was applied to glass by spin coating, was air-dried, was dried at 80° C. in vacuo, and thereby yielded a polysulfobutylbenzimidazole electrolyte membrane having a thickness of 45 μm. The polymer electrolyte membrane had an ionic conductivity at room temperature of 0.08 S/cm. The polymer electrolyte membrane was immersed in a 40 percent by weight aqueous methanol solution at 60° C. for seventy-two hours, was dried under reduced pressure, and was weighed. The polymer electrolyte membrane showed substantially no difference in dry weight between before and after immersion and was found to be insoluble in methanol.

In addition, the polymer electrolyte membrane was immersed in a Fenton's reagent at a temperature of 60° C. for twenty-four hours, was washed with water, was dried under reduced pressure, and the weight and ionic conductivity of the membrane were measured. The Fenton's reagent contained 1.9 mg of ferrous sulfate heptahydrate in 20 ml of a 30% aqueous hydrogen peroxide solution. The polymer electrolyte membrane showed high retentions in weight and ionic conductivity and was found to have good oxidation resistance.

### (3) Preparation of Membrane Electrode Assembly (MEA)

A membrane electrode assembly (MEA) (15) having a structure as shown in FIG. 3 was prepared in the following manner. Initially, a slurry was prepared by mixing a catalyst powder, 30 percent by weight of the polysulfomethylbenzimidazole electrolyte prepared in the step (1), and a solvent mixture of 1-propanol, 2-propanol, and methoxyethanol. The catalyst powder used herein contained a carbon carrier and 50 percent by weight of fine particles of a platinum/ruthenium alloy dispersed and supported on the carbon carrier, which alloy has an atomic ratio of platinum to ruthenium of 1:1.

The slurry was applied to a polyimide film by screen printing and thereby yielded an anode having a thickness of about 125 μm, a width of 30 mm, and a length of 30 mm. Next, another slurry was prepared by mixing a catalyst powder, a binder, and a solvent mixture of water and alcohols. The catalyst powder contained a carbon carrier and 30 percent by weight of platinum fine particles supported on the carbon carrier. The binder was a solution of a poly(perfluorosulfonic acid) in a solvent mixture of 1-propanol, 2-propanol, and methoxyethanol.

The slurry was applied to a polyimide film by screen printing and thereby yielded a cathode having a thickness of about 20 μm, a width of 30 mm, and a length of 30 mm. About 0.5 ml of a solution was allowed to permeate the surface of the anode. The solution was a 5 percent by weight solution of the polysulfomethylbenzimidazole electrolyte prepared in the step (1) in a solvent mixture of 1-propanol, 2-propanol, and methoxyethanol. The anode was then bonded with one side of the polysulfobutylbenzimidazole electrolyte membrane prepared in the step (3) and was dried at 80° C. under a load of 1 kg for three hours. Next, about 0.5 ml of another solution was allowed to permeate the surface of the cathode.

The solution was a 5 percent by weight solution of the polysulfomethylbenzimidazole electrolyte prepared in the step (2) in a solvent mixture of 1-propanol, 2-propanol, and methoxyethanol. The cathode was then bonded with the other side of the polysulfomethylbenzimidazole electrolyte membrane opposite to the anode layer, so that the cathode layer overlay the anode layer with the interposition of the membrane. The resulting article was dried at 80° C. under a load of about 1 kg for three hours and thereby yielded the membrane electrode assembly (MEA) (15).

### (4) Generation Performance of Fuel Cell (Direct-Methanol Fuel Cell (DMFC))

The membrane electrode assembly (MEA) (15) bearing the diffusion layers was mounted to a single cell of a solid polymer fuel cell generator having a structure as shown in FIG. 2, and the cell performance thereof was determined. FIG. 12 shows how the output voltage of the fuel cell varies depending on the current density. In FIG. 12, data indicated by the open rhombus ( [symbol] ) and filled rhombus (♦) represent data on the relationship between the output voltage and the current density and those on the relationship between the power density and the current density of the fuel cell, respectively.

The cell had an output voltage under a load at a current density of 50 mA/cm² of 0.46 V and showed a highest power density of 33 mW/cm². After 4000-hour operation under a load at a current density of 50 mA/cm², the cell had an output voltage of 0.42 V, about 90% or more of the initial output voltage, indicating that the cell can operate stably over extended periods of time.

### EXAMPLE 9

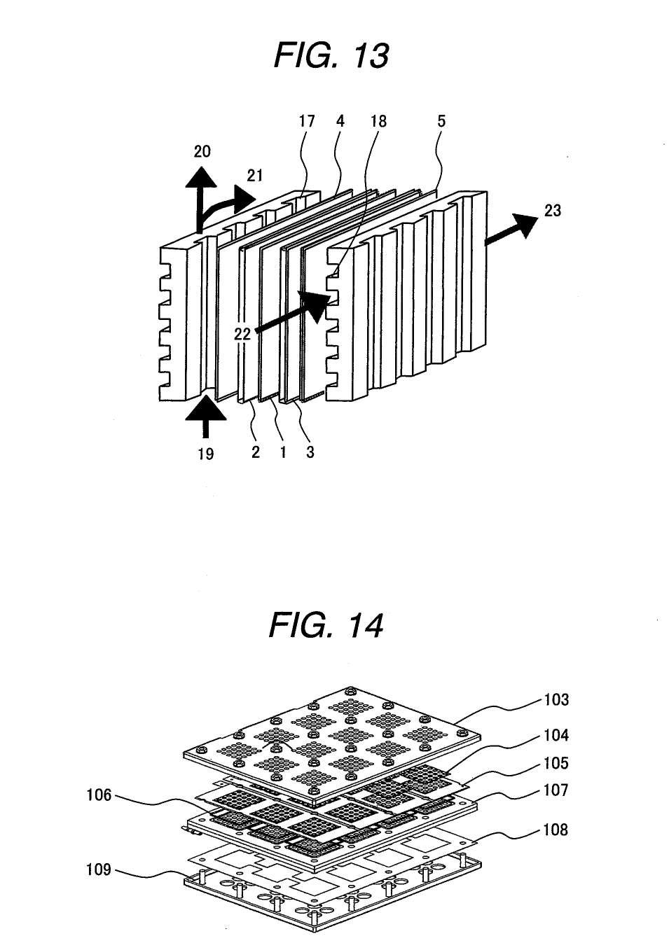

The membrane electrode assembly (MEA) (1) prepared according to Example 1 and bearing the diffusion layers was mounted to a compact single cell shown in FIG. 13 using hydrogen as a fuel, and the cell performance thereof was determined. FIG. 13 illustrates a polymer electrolyte membrane 1, an anode 2, a cathode 3, an anode diffusion layer 4, a cathode diffusion layer 5, a fuel pathway 17 of an electroconductive separator (bipolar plate) acting to separate electrode chambers and serving as a gas feed passage to the electrodes, an air pathway 18 of an electroconductive separator (bipolar plate) acting to separate electrode chambers and serving as a gas feed passage to the electrodes, a flow 19 of hydrogen and water, hydrogen 20, water 21, air 22, and a flow 23 of air and water.

The compact single cell was placed in a thermostatic bath, and the temperature of the thermostat bath was controlled so that a temperature measured by a thermocouple (not shown) placed in the separator stood at 70° C. The anode and cathode were humidified using an external humidifier, and the temperature of the humidifier was controlled within a range of 70° C. to 73° C. so that a dew point in the vicinity of an outlet of the humidifier stood at 70° C. The dew point was determined using a dew-point temperature sensor. In addition, the consumption of the humidifying water was continuously measured so as to verify that a dew point as determined from the flow rate, temperature, and pressure of reaction gas was a predetermined value.

The fuel cell was allowed to generate electricity for about eight hours a day under a load at a current density of 250 mA/cm², a hydrogen utilization of 70%, and an air utilization of 40% and to operate while keeping it hot during the remainder periods of time. Even after 7,000 hours, the fuel cell had an output voltage of 94% or more of the initial voltage. This demonstrates that a membrane electrode assembly according to an embodiment of the present invention is highly durable when used in a fuel cell using hydrogen as a fuel.

### EXAMPLE 10

### (1) Preparation of Fuel Cell

FIG. 14 shows the assemblage of a fuel cell 101 using the membrane electrode assembly prepared according to Example 1, by way of example. The fuel cell 101 was assembled by sequentially integrating a cathode end plate 103, a cathode current collector 104, a section 105 housing the membrane electrode assembly (MEA) bearing diffusion layers prepared according to Example 1, a packing 106, an anode end plate 107, a fuel tank 108, and an anode end plate 109 in this order using bolts and nuts.

### (2) Preparation of Fuel Cell Power Source

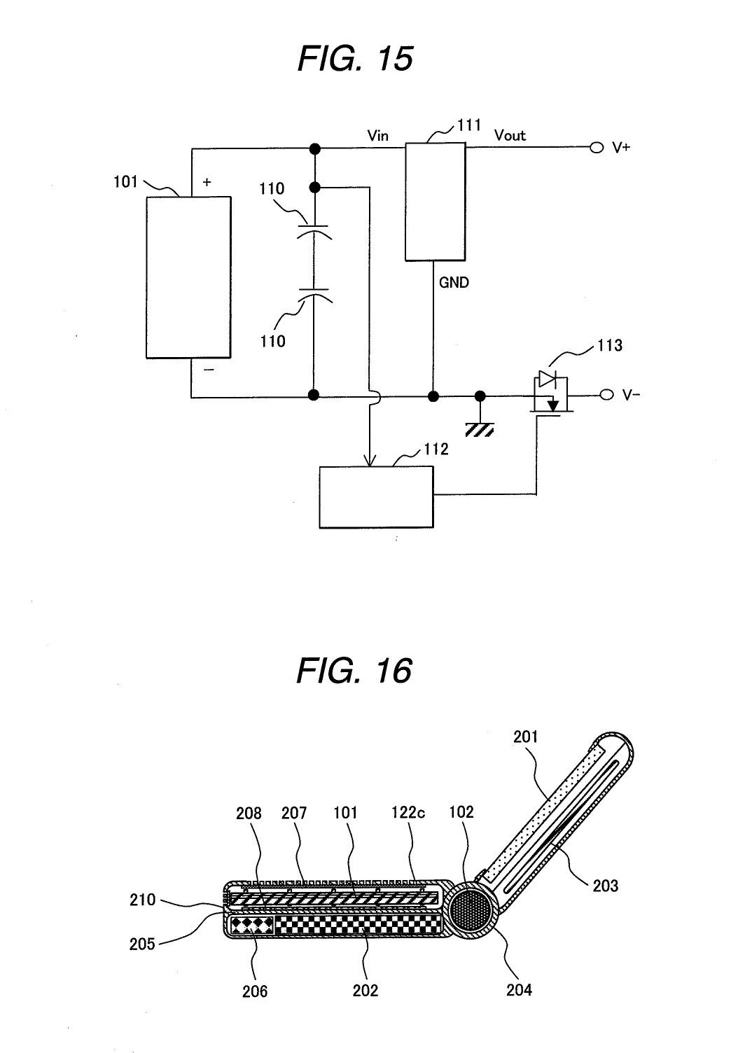

FIG. 15 shows an example of a power source system including the fuel cell 101. FIG. 15 illustrates the fuel cell 101, an electric double layer capacitor 110, a DC to DC converter 111, a load rejection switch 113, and a sensor/controller 112 configured to control ON/OFF of the load rejection switch 113. The power source illustrated in FIG. 15 includes electric double layer capacitors arrayed in series in two rows. The power source is configured in the following manner. The fuel cell 101 generates electricity, and the electric double layer capacitor 110 temporarily stores the electricity. The sensor/controller 112 determines the electricity in the electric double layer capacitor and allows the load rejection switch 113 to turn ON when a predetermined quantity of electricity is stored in the capacitor. The electricity is increased to a predetermined voltage by the action of the DC to DC converter and is then fed to an electronic device.

### (3) Preparation of Personal Digital Assistant

FIG. 16 illustrates a personal digital assistant including the fuel cell power source prepared in the step (2) by way of example. The personal digital assistant has a foldable structure including two units connected through a hinge with cartridge holder 204 serving also as a holder of a fuel cartridge 102. One of the two units includes an antenna 203 and a display unit 201 integrated with a touch-sensitive panel input device. The other unit includes the fuel cell 101, a motherboard 202, and a lithium ion secondary battery 206. The motherboard 202 includes electronic elements and electronic circuits such as processors, volatile and nonvolatile memories, an electric power controller, a hybrid controller for the fuel cell and the secondary battery, and a fuel monitor.

The section housing of the power source is partitioned by a partitioning plate 205 into a lower part and an upper part. The lower part houses the motherboard 202 and the lithium ion secondary battery 206, and the upper part houses the fuel cell power source 101. The upper and side walls of the cabinet have slits 122c for diffusing air and fuel exhaust gas. An air filter 207 is arranged on surface of the slits 122c in the cabinet, and a water-absorptive quick-drying material 208 is arranged on surface of the partitioning plate 205. The air filter may include any material that is capable of satisfactorily diffusing gases and capable of preventing entry of dust. The air filter is preferably a mesh or woven fabric containing a single yarn of a synthetic resin, because such a filter is resistant to clogging. A single yarn mesh of a water-repellent polytetrafluoroethylene, for example, may be used. The personal digital assistant stably operated over 2,000 hours or longer.

A direct-methanol fuel cell power source using amembrane electrode assembly according to an embodiment of the present invention is reduced in size and weight, is inexpensive, can be used over extended periods of time, and, if being refueled, can be continuously used. The fuel cell may be advantageously used as a battery charger for electronic devices having secondary batteries, or as an integrated power source for electronic devices using no secondary battery. Such electronic devices include, for example, mobile phones, mobile personal computers, mobile audio/visual devices, and other personal digital assistants. A solid polymer fuel cell using hydrogen as a fuel and including a membrane electrode assembly according to an embodiment of the present invention is reduced in size and weight, is inexpensive, and can be used over extended periods of time. This fuel cell is therefore useful typically as household or business cogeneration dispersed power sources, fuel cell power sources for mobile units, and mobile fuel cell power sources.

What is claimed is:

1. A hydrocarbon polymer electrolyte comprising at least one of structural units represented by Chemical Formula 1 and Chemical Formulae 2: 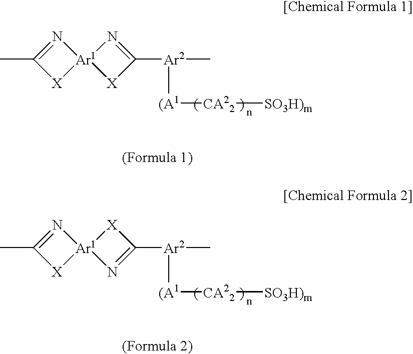
wherein Ar¹ and Ar² each independently represent an aromatic unit which may have one or more substituents such as aliphatic groups, aromatic groups, halogen groups, hydroxyl group, nitro group, cyano group, and trifluoromethyl group, these aromatic units may be any of monocyclic units such as benzene ring; fused units such as naphthalene, anthracene, and pyrene; and polycyclic aromatic units including two or more of these aromatic units bonded with each other through an optional bond, where the positions of nitrogen atoms and Xs in the aromatic unit are not limited, as long as these atoms constitute a benzazole ring, wherein these aromatic units include not only hydrocarbon aromatic units but also heterocyclic aromatic units typically containing nitrogen, oxygen, or sulfur in their aromatic ring; each of Xs independently represents one of O, S and NH; A¹ represents one of a direct bond, an oxygen bond (—O—), and a sulfur bond (—S—), bound to a carbon atom of an aromatic or heteroaromatic ring of the aromatic or heteroaromatic unit Ar²; A²s each independently represent fluorine or hydrogen; “n” represents an integer of 1 to 12; and “m” represents an integer of 1 to 4.

2. The hydrocarbon polymer electrolyte according to claim 1, wherein the at least one of the structural units represented by Chemical Formulae 1 and 2 is at least one of structural units represented by Chemical Formulae 3 and 4: 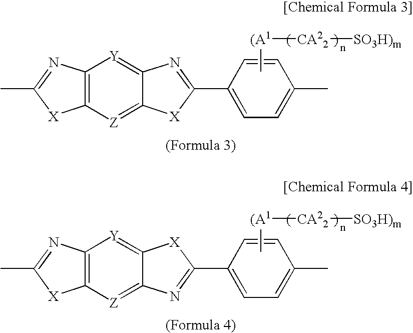
wherein each of Xs independently represents one of O, S, and NH; Y and Z each independently represent N or CH; A¹ represents one of a direct bond, an oxygen bond (—O—), and a sulfur bond (—S—), bound to a carbon atom of the benzene ring; A²s each independently represent fluorine or hydrogen; “n” represents an integer of 1 to 12; and “m” represents an integer of 1 to 4.

3. The hydrocarbon polymer electrolyte according to one of claims 1 and 2, wherein the hydrocarbon polymer electrolyte has an ionic conductivity of 0.07 S/cm or more, and wherein the hydrocarbon polymer electrolyte shows substantially no deterioration after the electrolyte is immersed in a Fenton's reagent containing 1.9 mg of ferrous sulfate heptahydrate in 20 ml of a 30% aqueous hydrogen peroxide solution at a temperature of 60° C. for twenty-four hours.

4. The hydrocarbon polymer electrolyte according to any one of claims 1 to 3, wherein the hydrocarbon polymer electrolyte has an ionic equivalent of 0.5 to 2.5 meq/g.

5. The hydrocarbon polymer electrolyte according to any one of claims 1 to 4, as a block polymerization product of a first copolymer and a second copolymer, wherein the first copolymer is a copolymer of at least one selected from the group consisting of aromatic diamine derivatives represented by following Chemical Formulae 16 and 17, and salts thereof, with at least one selected from aromatic dicarboxylic acid derivatives represented by following Chemical Formula 18, and wherein the second copolymer is a copolymer of at least one selected from the group consisting of aromatic diamine derivatives represented by following Chemical Formulae 16 and 17, and salts thereof, with at least one selected from aromatic dicarboxylic acid derivatives represented by following Chemical Formula 19: 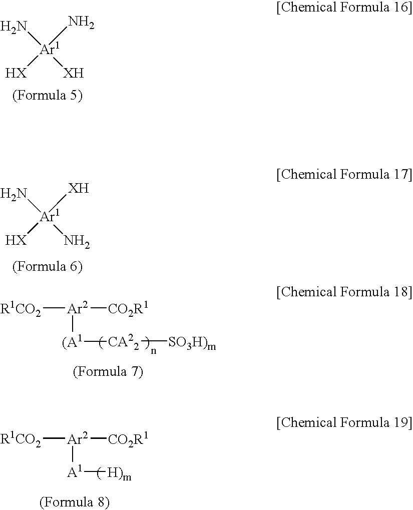
wherein each of Xs independently represents one of O, S, and NH; Ar¹ represents a quadrivalent aromatic group having zero to four carbon atoms; Ar² represents an aromatic group having six to twenty carbon atoms; A¹ represents one of a direct bond, O, and S; A²s each independently represent fluorine or hydrogen; “n” represents an integer of 1 to 12; and “m” represents an integer of 1 to 4.

6. A hydrocarbon polymer electrolyte as a film formed from the hydrocarbon polymer electrolyte according to any one of claims 1 to 5, wherein at least one of nitrogen atoms in imidazole rings has an alkylene group, an alkylenesulfonic group, or an alkylenesulfonic group.

7. A hydrocarbon polymer electrolyte membrane comprising a film formed from the hydrocarbon polymer electrolyte according to any one of claims 1 to 6.

8. A membrane electrode assembly comprising an anode including a carbon material, an electrode catalyst supported on the carbon material, and a polymer electrolyte; a cathode including a carbon material, an electrode catalyst supported on the carbon material, and a polymer electrolyte; and a polymer electrolyte membrane arranged between the anode and the cathode, wherein the polymer electrolyte membrane is the hydrocarbon polymer electrolyte membrane of claim 7.

9. A membrane electrode assembly comprising an anode including a carbon material, an electrode catalyst supported on the carbon material, and a polymer electrolyte; a cathode including a carbon material, an electrode catalyst supported on the carbon material, and a polymer electrolyte; and a polymer electrolyte membrane arranged between the anode and the cathode, wherein the polymer electrolyte includes the hydrocarbon polymer electrolyte according to any one of claims 1 to 7.

10. A fuel cell comprising the membrane electrode assembly according to one of claims 8 and 9.

11. A fuel cell power source comprising the fuel cell according to claim 10.

12. An electronic device comprising the fuel cell power source according to claim 11.
